(19) United States
(12) Patent Application Publication
(10) Pub. No.: US 2024/0170825 A1
(43) Pub. Date: May 23, 2024

(54) FILTER

(71) Applicant: SOSHIN ELECTRIC CO., LTD., Saku-City (JP)

(72) Inventors: Yoshiharu IMAI, Saku-City (JP); Yuichi MIYATA, Saku-City (JP); Genta NISHIO, Saku-City (JP); Shun SUZUKI, Saku-City (JP); Kazuya ADACHI, Saku-City (JP); Hiroyuki ISONO, Saku-City (JP); Kazuma KOSAKA, Saku-City (JP)

(73) Assignee: SOSHIN ELECTRIC CO., LTD., Saku-City (JP)

(21) Appl. No.: 18/552,488

(22) PCT Filed: Feb. 28, 2022
(86) PCT No.: PCT/JP2022/008133

§ 371 Date: Sep. 26, 2023

(30) Foreign Application Priority Data
Mar. 31, 2021 (JP) 2021-062366

(51) Int. Cl. H01P 1/205; H01P 7/10

(52) U.S. Cl. CPC H01P 1/2056; H01P 7/10

(57) ABSTRACT

This filter comprises: a dielectric substrate; a plurality of resonators that are formed inside the dielectric substrate, and for which the periphery is surrounded by a shielding conductor; and input/output terminals that are formed at a portion at which the shielding conductor is not formed. The resonator closest to the input/output terminal of the plurality of resonators and the resonator that is closest to the input/output terminal of the plurality of resonators are in a point-symmetrical positional relationship.

### TECHNICAL FIELD

The present invention relates to a filter.

### BACKGROUND ART

JP 2011-507312 A discloses a resonator device provided with via holes for adjusting the coupling between two resonators. According to JP 2011-507312 A, the inductive coupling (degree of coupling) between the two resonators can be adjusted by the via holes for coupling adjustment.

JP 2020-198482 A proposes a small-scale filter that has excellent characteristics for solving the problems of the resonator device disclosed in JP 2011-507312 A. Specifically, J P 2020-198482 A proposes a filter that is capable of solving the problem that the size of the filter increases when the distance between resonators is increased.

Furthermore, JP 2020-198482 A proposes a structure capable of improving the Q value compared to the conventional art, by suitably ensuring the distance between resonators and the distance from a shield conductor. By adopting this structure, it became possible to consider a filter with less insertion loss and a filter with a greater attenuation amount, compared to the conventional art.

### SUMMARY OF THE INVENTION

In JP 2020-198482 A, a filter with higher performance realized by adopting the above structure can be considered, but when applied to the filter, the attenuation amount cannot be sufficiently ensured due to manufacturing variation, and so the desired filter characteristics cannot be ensured. Even within a resonator arrangement that realizes a high Q value, there are cases where there is large variation among the degrees of coupling according to the arrangement method.

The present invention has the object of providing a small-scale filter with excellent characteristics.

A filter according to one aspect of the present invention includes a dielectric substrate; a plurality of resonators that are formed within the dielectric substrate and surrounded by shield conductors; and a first input/output terminal and a second input/output terminal formed in a portion where the shield conductors are not formed. A first resonator, which is a resonator nearest the first input/output terminal among the plurality of resonators, and a second resonator, which is a resonator nearest the second input/output terminal among the plurality of resonators, are arranged in a positional relationship with point symmetry, with a center of the dielectric substrate in a planar view being a center of the point symmetry; a third resonator among the plurality of resonators and a fourth resonator among the plurality of resonators are arranged in a positional relationship with point symmetry, with the center of the dielectric substrate in the planar view being a center of the point symmetry; a position of the third resonator in a first direction, which is a longitudinal direction of the dielectric substrate, is between a position of the first resonator in the first direction and a position of the center of the dielectric substrate in the first direction; and a position of the fourth resonator in the first direction is between a position of the second resonator in the first direction and the position of the center of the dielectric substrate in the first direction.

According to the present invention, it is possible to provide a small-scale filter with excellent characteristics.

### BRIEF DESCRIPTION OF DRAWINGS

FIG. 1 is a perspective view of a filter according to a first embodiment;

FIG. 2 is a planar view of the filter according to the first embodiment;

FIG. 3A is a diagram showing an ideal filter waveform;

FIG. 3B is a diagram showing a filter waveform having variations;

FIG. 4A is a descriptive diagram showing an example in which a plurality of resonators are arranged with line symmetry;

FIG. 4B is a descriptive diagram showing an example in which a plurality of resonators are arranged with point symmetry;

FIG. 5A is a graph showing fluctuation of a filter waveform according to Comparative Example 1 relative to the ideal filter waveform;

FIG. 5B is a graph showing fluctuation of a filter waveform according to Comparative Example 1 relative to the ideal filter waveform;

FIG. 6A is a graph showing fluctuation of a filter waveform according to Embodiment Example 1 relative to the ideal filter waveform;

FIG. 6B is a graph showing fluctuation of a filter waveform according to Embodiment Example 1 relative to the ideal filter waveform;

FIG. 7A is a side view of a capacitive coupling structure between via electrodes in a filter according to Comparative Example 2;

FIG. 7B is a top surface view of the capacitive coupling structure;

FIG. 7C is a side view of the capacitive coupling structure;

FIG. 8 is a graph showing frequency characteristics of the filter according to Comparative Example 2;

FIG. 9A is a side view of a capacitive coupling structure between via electrodes in a filter according to Embodiment Example 2;

FIG. 9B is a top surface view of the capacitive coupling structure;

FIG. 9C is a side view of the capacitive coupling structure;

FIG. 10 is a graph showing frequency characteristics of the filter according to Embodiment Example 2;

FIG. 11A is an equivalent circuit diagram showing the capacitive coupling structure between via electrode portions connected in series;

FIG. 11B is a schematic view of an arrangement example of a plurality of flat electrodes in the case of a serial connection;

FIG. 11C is a planar view schematically showing an example of a positional correction of the flat electrodes;

FIG. 12A is an equivalent circuit diagram showing the capacitive coupling structure between via electrode portions connected in parallel;

FIG. 12B is a schematic view of an arrangement example of a plurality of flat electrodes in the case of a parallel connection;

FIG. 13A is an equivalent circuit diagram showing the capacitive coupling structure between via electrode portions connected in series;

FIG. 13B is a schematic view of another arrangement example of a plurality of flat electrodes in the case of a serial connection;

FIG. 13C is an equivalent circuit diagram showing the capacitive coupling structure between via electrode portions connected in parallel;

FIG. 13D is a schematic view of another arrangement example of a plurality of flat electrodes in the case of a parallel connection;

FIG. 14 is a planar view of an arrangement relationship f capacitive electrodes in Comparative Example 3;

FIG. 15 is a waveform diagram showing the frequency characteristics of Comparative Example 3;

FIG. 16 is a planar view of an arrangement relationship of capacitive electrodes in Embodiment Example 3;

FIG. 17 is a waveform diagram showing the frequency characteristics of Embodiment Example 3;

FIG. 18 is a perspective view of a filter according to a second embodiment;

FIG. 19 is a planar view of the filter according to the second embodiment;

FIG. 20A is a cross-sectional view of a portion of the filter according to the second embodiment;

FIG. 20B is a cross-sectional view of a portion of the filter according to the second embodiment;

FIG. 21 is a perspective view of the filter according to the second embodiment;

FIG. 22 is a perspective view of the filter according to the second embodiment;

FIG. 23 is a planar view of the filter according to the second embodiment;

FIG. 24 is a perspective view of the filter according to the second embodiment;

FIG. 25 is a planar view of the filter according to the second embodiment;

FIG. 26 is a perspective view of the filter according to the second embodiment;

FIG. 27 is a planar view of the filter according to the second embodiment;

FIG. 28 is a planar view of the filter according to the second embodiment;

FIG. 29 is a planar view of a filter according to a modified embodiment;

FIG. 30 is a planar view of a filter according to a modified embodiment;

FIG. 31 is a planar view of a filter according to a modified embodiment.

### DETAILED DESCRIPTION OF THE INVENTION

The following describes the details of a filter according to the present invention by providing examples of preferred embodiments, while referencing the accompanying drawings.

### First Embodiment

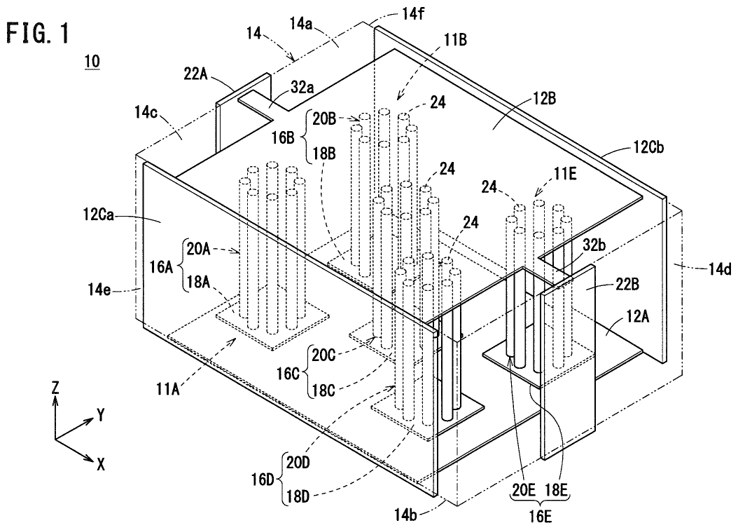

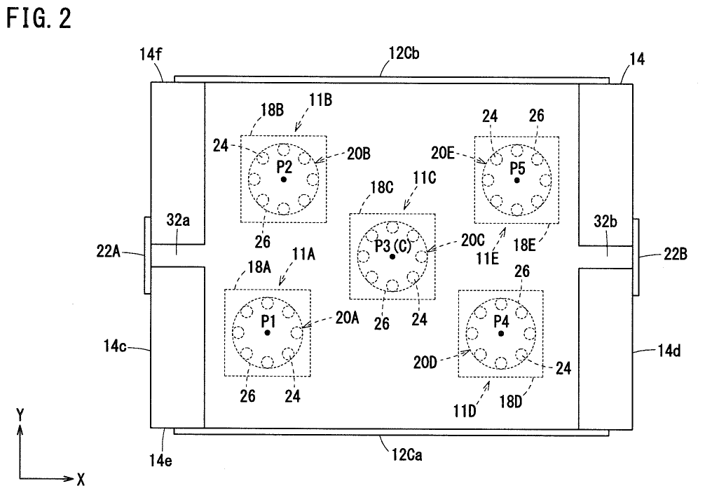

A filter 10 according to a first embodiment will be described while referencing the drawings. FIG. 1 is a perspective view of the filter 10 according to the present embodiment. FIG. 2 is a planar view of the filter 10 according to the present embodiment. FIGS. 1 and 2 show an example of a case in which five resonators 11A to 11E are provided.

As shown in FIGS. 1 and 2, the filter 10 according to the present embodiment includes a dielectric substrate 14. The dielectric substrate 14 is formed to have a rectangular parallelepiped shape, for example, but is not limited to this. The dielectric substrate 14 is formed by stacking a plurality of ceramic sheets (dielectric ceramic sheets).

The dielectric substrate 14 includes two principal surfaces 14a and 14b and four side surfaces 14c to 14f. A direction along the normal direction of the side surface 14c and side surface 14d, more specifically, the normal direction of the side surfaces 14c and 14d, is the X direction. That is, the longitudinal direction of the dielectric substrate 14 in a planar view is the X direction. A direction along the normal direction of the side surface 14e and side surface 14f, more specifically, the normal direction of the side surfaces 14e and 14f, is the Y direction. A direction along the normal direction of one principal surface (first principal surface) 14a and the other principal surface (second principal surface) 14b of the dielectric substrate 14, more specifically, the normal direction of the principal surfaces 14a and 14b, is the Z direction.

A shield conductor (first-principal-surface-side shield conductor or lower shield conductor) 12A is formed on the principal surface 14b side of the dielectric substrate 14. That is, the shield conductor 12A is formed on the lower side of the dielectric substrate 14 in FIG. 1. A shield conductor (second-principal-surface-side shield conductor or upper shield conductor) 12B is formed on the principal surface 14a side of the dielectric substrate 14. That is, the shield conductor 12B is formed on the upper side of the dielectric substrate 14 in FIG. 1.

An input/output terminal 22A is formed on the side surface 14c of the dielectric substrate 14. An input/output terminal 22B is formed on the side surface 14d of the dielectric substrate 14. The input/output terminal 22A is coupled to the shield conductor 12B via a connection line 32a. The input/output terminal 22B is coupled to the shield conductor 12B via a connection line 32b. In FIGS. 1 and 2, an example is shown in which the input/output terminals 22A and 22B are connected to the shield conductor 12B, but the input/output terminals 22A and 22B may be connected to each of the resonators 11A and 11E.

A shield conductor 12Ca is formed on the side surface 14e of the dielectric substrate 14. A shield conductor 12Cb is formed on the side surface 14f of the dielectric substrate 14. The shield conductors 12Ca and 12Cb are formed as boards.

Capacitor electrodes (strip lines) 18A to 18E facing the shield conductor 12A are formed within the dielectric substrate 14. In FIG. 1, the capacitor electrodes 18A to 18E are shown as having square shapes, but the shapes of the capacitor electrodes 18A to 18E are not limited to squares. As an example, the shapes of the capacitor electrodes 18A to 18E may be rectangles. The reference numeral 18 is used when describing a capacitor electrode in general, and the reference numerals 18A to 18E are used when describing individual capacitor electrodes.

A via electrode portion 20A, a via electrode portion 20B, a via electrode portion 20C, a via electrode portion 20D, and a via electrode portion 20E are also formed within the dielectric substrate 14. The reference numeral 20 is used when describing a via electrode portion in general, and the reference numerals 20A to 20E are used when describing individual via electrode portions.

Each via electrode portion 20 is formed by a plurality of via electrodes 24. The via electrodes 24 are embedded respectively in via holes formed in the dielectric substrate 14. As shown in FIG. 2, the plurality of via electrodes 24 forming each via electrode portion 20 are arranged along an imaginary ring 26, when viewed from above. More specifically, the plurality of via electrodes 24 forming the via electrode portion 20 are arranged along an imaginary circle. Since the via electrode portion 20 is formed by arranging the plurality of via electrodes 24 along the imaginary ring 26, the via electrode portion 20 can behave like a large-diameter via electrode corresponding to the imaginary ring 26. Since the via electrode portion 20 is formed by the plurality of via electrodes 24 that each have a relatively small diameter, the manufacturing process can be simplified. Furthermore, since the via electrode portion 20 is formed by the plurality of via electrodes 24 that each have a relatively small diameter, the variation in diameter among the via electrode portions 20 can be reduced. Yet further, since the via electrode portion 20 is formed by the plurality of via electrodes 24 that each have a relatively small diameter, less material such as silver to be embedded in the vias is needed, and so the cost can be reduced.

One end (bottom end) of the via electrode portion 20 is connected to the capacitor electrode 18. The other end (top end) of the via electrode portion 20 is connected to the shield conductor 12B. In this way, the via electrode portion 20 is formed from the capacitor electrode 18 to the shield conductor 12B.

A structure body 16A is formed by the capacitor electrode 18A and the via electrode portion 20A. A structure body 16B is formed by the capacitor electrode 18B and the via electrode portion 20B. A structure body 16C is formed by the capacitor electrode 18C and the via electrode portion 20C. Similarly, a structure body 16D is formed by the capacitor electrode 18D and the via electrode portion 20D. A structure body 16E is formed by the capacitor electrode 18E and the via electrode portion 20E. The reference numeral 16 is used when describing a structure body in general, and the reference numerals 16A to 16E are used when describing individual structure bodies. Patterns (not shown in the drawings) can be suitably provided between respective structure bodies 16.

The filter 10 includes a plurality of resonators that respectively include the structure bodies 16A to 16E. That is, the filter 10 includes a resonator 11A, a resonator 11B, a resonator 11C, a resonator 11D, and a resonator 11E. The reference numeral 11 is used when describing a resonator in general, and the reference numerals 11A to 11E are used when describing individual resonators.

The resonator 11A and resonator 11B are arranged adjacent to each other. The resonator 11B and resonator 11C are arranged adjacent to each other. The resonator 11C and resonator 11D are arranged adjacent to each other. The resonator 11D and resonator 11E are arranged adjacent to each other. One via electrode portion 20 is provided to each of the plurality of resonators 11.

As shown in FIG. 2, the via electrode portion 20A, the via electrode portion 20B, the via electrode portion 20C, the via electrode portion 20D, and the via electrode portion 20E are shifted from each other in the X direction. The position of the center P3 of the via electrode portion 20C in the X direction is between the position of the center P1 of the via electrode portion 20A in the X direction and the position of the center P5 of the via electrode portion 20E in the X direction. Preferably, the distance between the position of the center P3 of the via electrode portion 20C in the X direction and the position of the center P1 of the via electrode portion 20A in the X direction is equal to the distance between the position of the center P3 of the via electrode portion 20C in the X direction and the position of the center P5 of the via electrode portion 20E in the X direction.

Similarly, the position of the center P3 of the via electrode portion 20C in the Y direction is between the position of the center P1 of the via electrode portion 20A in the Y direction and the position of the center P5 of the via electrode portion 20E in the Y direction. Preferably, the distance between the position of the center P3 of the via electrode portion 20C in the Y direction and the position of the center P1 of the via electrode portion 20A in the Y direction is equal to the distance between the position of the center P3 of the via electrode portion 20C in the Y direction and the position of the center P5 of the via electrode portion 20E in the Y direction. The position of the center P1 of the via electrode portion 20A in the Y direction and the position of the center P4 of the via electrode portion 20D in the Y direction are the same. Similarly, the position of the center P2 of the via electrode portion 20B in the Y direction and the position of the center P5 of the via electrode portion 20E in the Y direction are the same.

Among the five via electrode portions 20A to 20E, the via electrode portion 20 closest to the input/output terminal 22A is the via electrode portion 20A. That is, the distance in the X direction between the position of the center P1 of the via electrode portion 20A and the position of the input/output terminal 22A is less than the distance in the X direction between the position of the center P2 of the via electrode portion 20B and the position of the input/output terminal 22A. Among the five via electrode portions 20A to 20E, the via electrode portion 20 closest to the input/output terminal 22B is the via electrode portion 20E. The distance in the X direction between the position of the center P5 of the via electrode portion 20E and the position of the input/output terminal 22B is less than the distance in the X direction between the position of the center P4 of the via electrode portion 20D and the position of the input/output terminal 22B. The via electrode portion 20A and the via electrode portion 20D are positioned on the side surface 14e side. The via electrode portion 20B and the via electrode portion 20E are positioned on the side surface 14f side.

### EMBODIMENT EXAMPLES

The following shows results obtained by confirming differences in characteristics between embodiment examples and comparative examples.

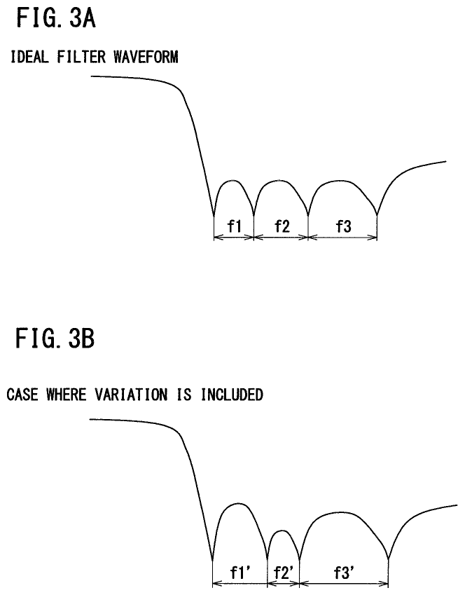

First, in the ideal filter waveform shown in FIG. 3A, the variation among the intervals between attenuation poles is small and the variation among peak values is also small. In contrast to this, in the filter waveform of a filter having variation, such as shown in FIG. 3B, the variation among the intervals between attenuation poles is large and the variation among peak values is also large. As a result, the desired attenuation characteristics cannot be realized with a filter including variation. The causes of this are that there is variation among the degrees of coupling of the resonators, there is variation among the coupling capacitances, there is variation among the jump capacitances, and the like, for example.

### First Embodiment Example

### Comparative Example 1

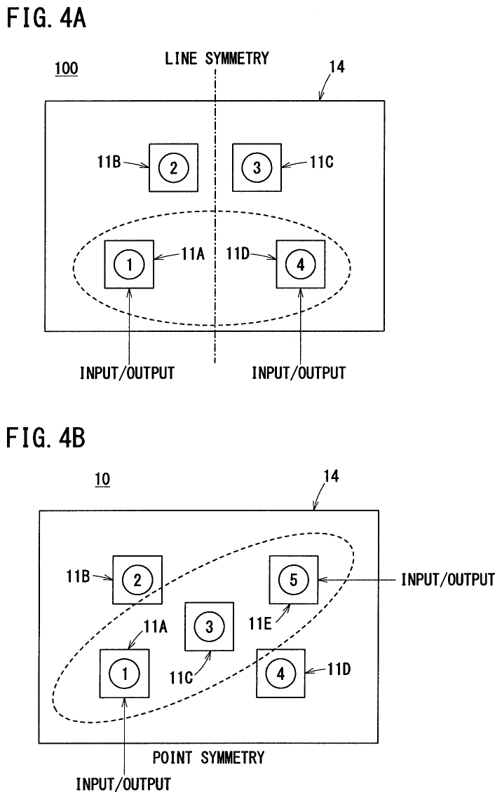

As shown in FIG. 4A, a filter 100 according to Comparative Example 1 includes four resonators 11A to 11D. These resonators 11A to 11D are arranged at positions having line symmetry, with the center line of the dielectric substrate 14 in a planar view as the axis of symmetry. The resonator 11A and the resonator 11D correspond to each other. The resonator 11B and the resonator 11C correspond to each other. In other words, the filter 100 of Comparative Example 1 has a structure in which a combination of the via electrode portion 20A and the via electrode portion 20B and a combination of the via electrode portion 20C and the via electrode portion 20D are arranged at positions having line symmetry relative to each other.

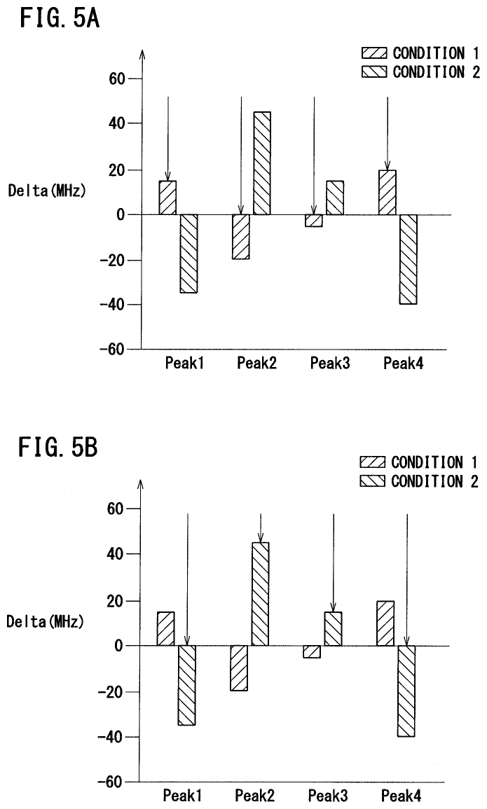

As shown in FIGS. 5A and 5B, the filter waveform of the filter 100 according to Comparative Example 1 exhibited large variations and the fluctuation directions (+ or −) of these variations were also varied, compared to the ideal filter waveform.

### Embodiment Example 1

As shown in FIG. 4B, the filter according to Embodiment Example 1 includes five resonators 11A to 11E. These resonators 11A to 11E are arranged at positions having point symmetry, with the center C (see FIG. 2) of the dielectric substrate 14 in the planar view as the center of symmetry. The resonator 11A and the resonator 11E correspond to each other. That is, the resonator 11A, which is the shortest distance from the input/output terminal 22A, and the resonator 11E, which is the shortest distance from the input/output terminal 22B, are arranged to have point symmetry. Furthermore, the resonator 11B and the resonator 11D correspond to each other. In other words, the filter according to Embodiment Example 1 has a structure in which the via electrode portion 20A, which is closest to one input/output, and the via electrode portion 20E, which is closest to the other input/output, are arranged at positions having point symmetry. The via electrode portion 20B and the via electrode portion 20D are also arranged at positions having point symmetry.

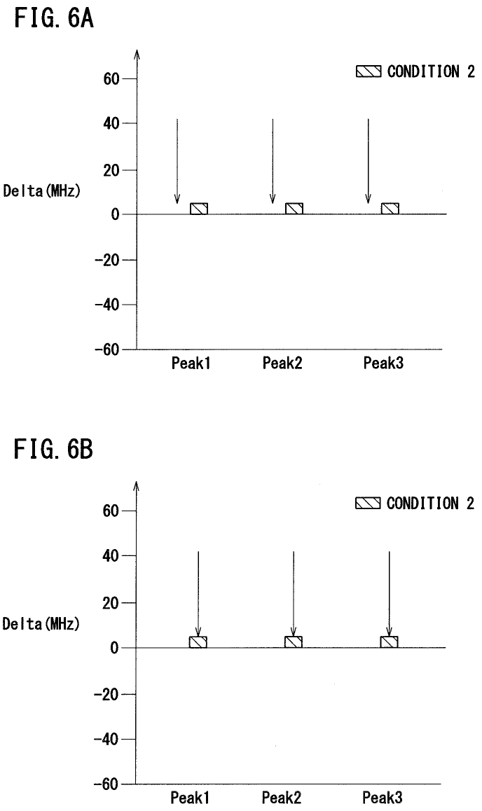

As shown in FIGS. 6A and 6B, the filter according to Embodiment Example 1 had small variations and the fluctuation direction was constant, compared to the ideal filter waveform.

### Second Embodiment Example

### Comparative Example 2

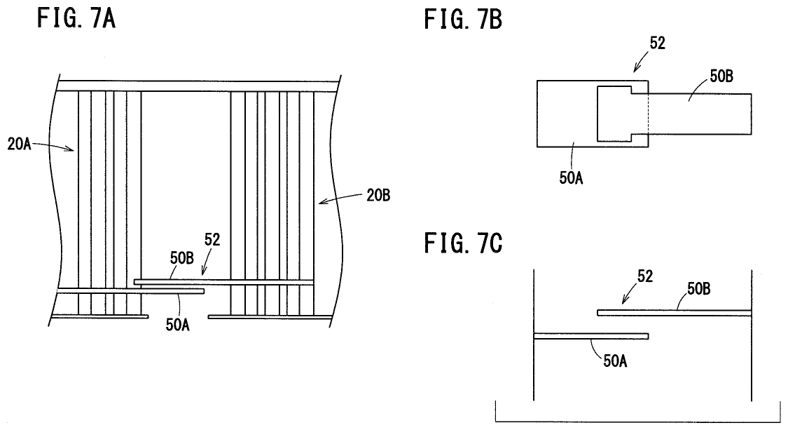

As shown in FIGS. 7A to 7C, a capacitive coupling structure 52 is included between the via electrode portions 20 of the filter according to Comparative Example 2. In this capacitive coupling structure 52, a tip portion of a flat electrode 50A coupled to the via electrode portion 20A and a tip portion of a flat electrode 50B coupled to the via electrode portion 20B are separated from each other in a side view. Furthermore, in this capacitive coupling structure 52, the tip portion of the flat electrode 50A coupled to the via electrode portion 20A and the tip portion of the flat electrode 50B coupled to the via electrode portion 20B overlap with each other in the planar view. Specifically, the tip portion of the flat electrode 50A and the tip portion of the flat electrode 50B face each other. The reference numeral 50 is used when describing a flat electrode in general, and the reference numerals 50A to 50D are used when describing individual flat electrodes.

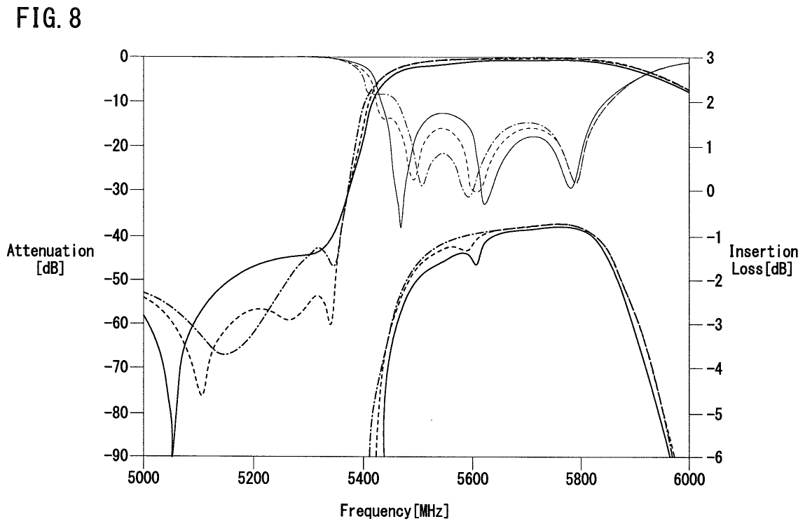

The frequency characteristics of the filter according to Comparative Example 2 were such that there was large variation of the attenuation characteristic in the low frequency region, as shown in FIG. 8.

### Embodiment Example 2

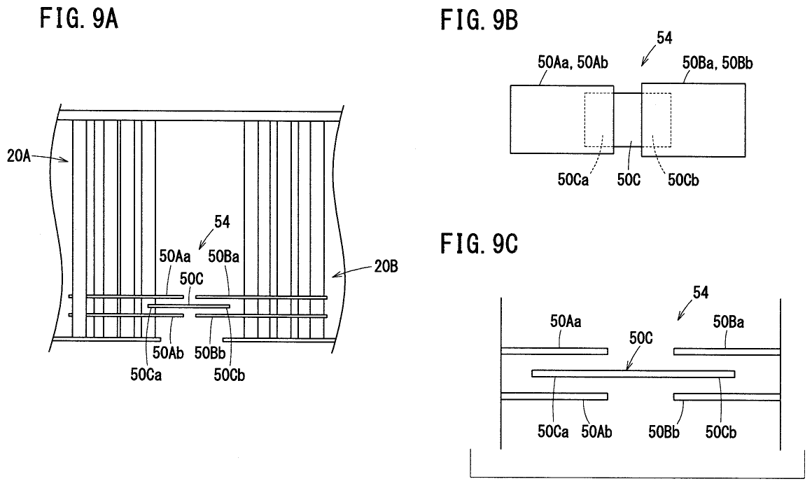

The filter according to Embodiment Example 2 is provided with a capacitive coupling structures 54 between the via electrode portions 20. This capacitive coupling structure 54 is provided between each set of adjacent via electrode portions 20. An example of the capacitive coupling structure 54 provided between the via electrode portion 20A and the via electrode portion 20B is shown in FIGS. 9A to 9C. The capacitive coupling structure 54 shown in FIGS. 9A to 9C includes two flat electrodes 50Aa and 50Ab that are coupled to the via electrode portion 20A, two flat electrodes 50Ba and 50Bb that are coupled to the via electrode portion 20B, and a flat electrode 50C. One tip portion 50Ca of the flat electrode 50C is positioned between the flat electrode 50Aa and the flat electrode 50Ab, in the side view. The tip portion 50Ca of the flat electrode 50C and the flat electrode 50Aa are separated from each other, in the side view. The tip portion 50Ca of the flat electrode 50C and the flat electrode 50Ab are separated from each other, in the side view. The tip portion 50Ca of the flat electrode 50C and the flat electrode 50Aa overlap with each other, in the planar view. Specifically, the tip portion 50Ca of the flat electrode 50C and the flat electrode 50Aa face each other. The tip portion 50Ca of the flat electrode 50C and the flat electrode 50Ab overlap with each other, in the planar view. Specifically, the tip portion 50Ca of the flat electrode 50C and the flat electrode 50Ab face each other. The other tip portion 50Cb of the flat electrode 50C is positioned between the flat electrode 50Ba and the flat electrode 50Bb, in the side view. The tip portion 50Cb of the flat electrode 50C and the flat electrode 50Ba are separated from each other, in the side view. The tip portion 50Cb of the flat electrode 50C and the flat electrode 50Bb are separated from each other, in the side view. The tip portion 50Cb of the flat electrode 50C and the flat electrode 50Ba overlap with each other, in the planar view. Specifically, the tip portion 50Cb of the flat electrode 50C and the flat electrode 50Ba face each other. The tip portion 50Cb of the flat electrode 50C and the flat electrode 50Bb overlap with each other, in the planar view. Specifically, the tip portion 50Cb of the flat electrode 50C and the flat electrode 50Bb face each other.

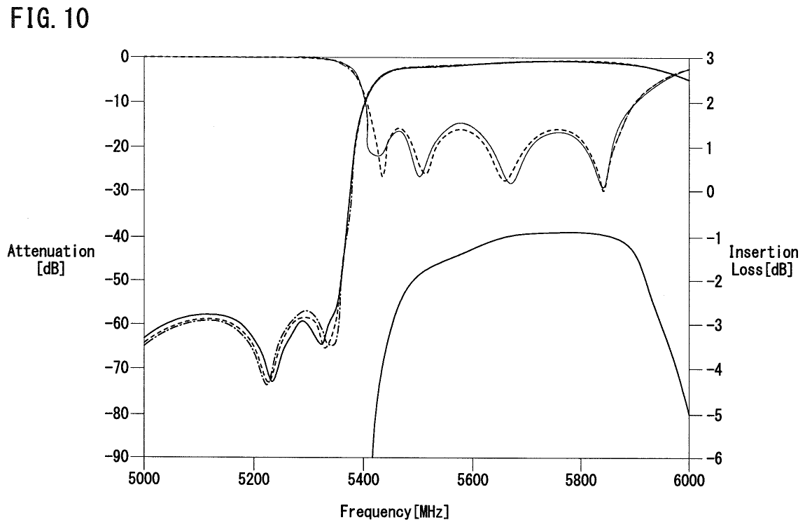

The frequency characteristics of the filter according to Embodiment Example 2 were such that there was little variation of the attenuation characteristic in the low frequency region, as shown in FIG. 10. That is, with the filter according to Embodiment Example 2, there is almost no variation in the attenuation characteristic in the low frequency region.

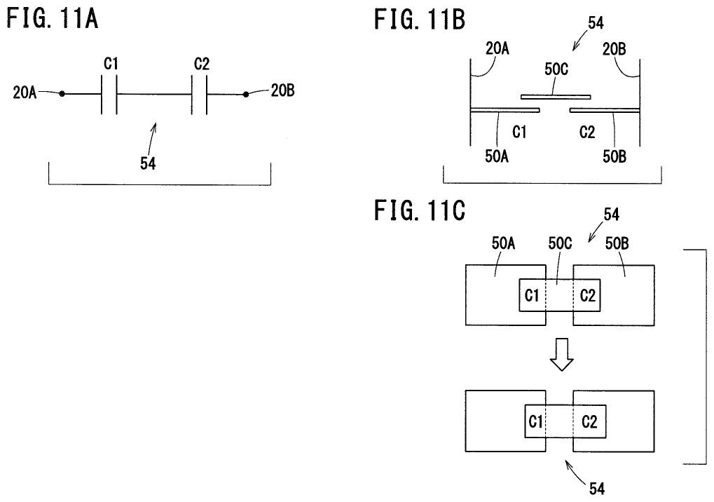

The capacitive coupling structure 54 provided between the via electrode portion 20 is not limited to the structure described above. As an example, a capacitive coupling structure 54 such as shown in FIG. 11A may be provided between the via electrode portions 20. As another example, the structure shown in FIG. 11B may be adopted as a capacitive coupling structure 54 in which a capacitance C1 and a capacitance C2 are connected in series.

In the capacitive coupling structure 54 shown in FIG. 11B, the tip portion of the flat electrode 50A extending from the via electrode portion 20A and the tip portion of the flat electrode 50B extending from the via electrode portion 20B are separated from each other. In this capacitive coupling structure 54, the tip portion of the flat electrode 50A and the flat electrode 50C are separated from each other in the side view. In this capacitive coupling structure 54, the tip portion of the flat electrode 50B and the flat electrode 50C are separated from each other in the side view. In this capacitive coupling structure 54, the tip portion of the flat electrode 50A and the flat electrode 50C overlap with each other in the planar view. That is, the tip portion of the flat electrode 50A and the flat electrode 50C face each other. In this capacitive coupling structure 54, the tip portion of the flat electrode 50B and the flat electrode 50C overlap with each other in the planar view. That is, the tip portion of the flat electrode 50B and the flat electrode 50C face each other.

In this case, the capacitance C1 formed by the flat electrode 50A and the flat electrode 50C may be the same as the capacitance C2 formed by the flat electrode 50B and the flat electrode 50C, or may be different therefrom. The diagram in the upper portion of FIG. 11C shows an example in which the capacitance C1 and the capacitance C2 are the same. The diagram in the bottom portion of FIG. 11C shows an example in which the position of the flat electrode 50C is shifted to make the capacitance C2 larger than the capacitance C1. Instead, the capacitance C1 may be made larger than the capacitance C2 by shifting the position of the flat electrode 50C.

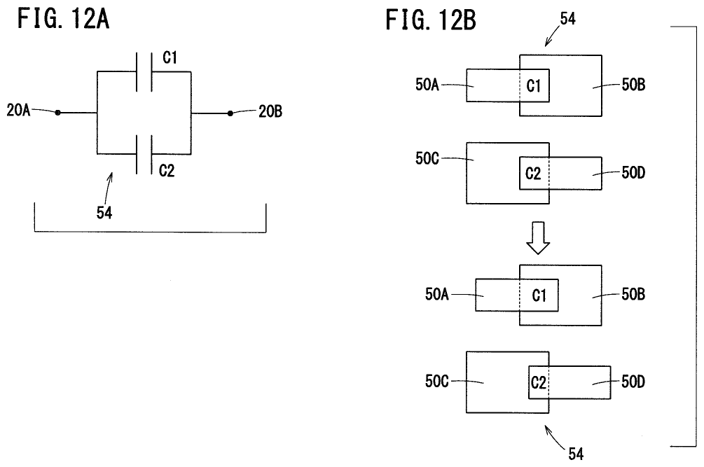

The capacitive coupling structure 54 provided between the via electrode portions 20 is not limited to the structure described above. As an example, a capacitive coupling structure 54 such as shown in FIG. 12A may be provided between the via electrode portions 20. As another example, the structure shown in FIG. 12B may be adopted as a capacitive coupling structure 54 in which a capacitance C1 and a capacitance C2 are connected in parallel.

In the capacitive coupling structure 54 shown in FIG. 12B, the tip portion of the flat electrode 50A extending from the via electrode portion 20A and the tip portion of the flat electrode 50B extending from the via electrode portion 20B overlap with each other in the planar view. The flat electrode 50A and the flat electrode 50B are separated from each other in the side view. That is, the tip portion of the flat electrode 50A and the tip portion of the flat electrode 50B face each other. In the capacitive coupling structure 54 shown in FIG. 12B, the tip portion of the flat electrode 50C extending from the via electrode portion 20A and the tip portion of the flat electrode 50D extending from the via electrode portion 20B overlap with each other in the planar view. The flat electrode 50C and the flat electrode 50D are separated from each other in the side view. That is, the tip portion of the flat electrode 50C and the tip portion of the flat electrode 50D face each other. The flat electrode 50A and flat electrode 50D may be formed at respective positions in the same layer, and the flat electrode 50B and flat electrode 50C may be formed at respective positions in the same layer. In this case, the layer in which the flat electrode 50A and the flat electrode 50D are formed and the layer in which the flat electrode 50B and the flat electrode 50C are formed may be different from each other.

As shown in FIG. 12B, the capacitance C1 between the flat electrode 50A and the flat electrode 50B may be suitably adjusted by changing the relative positional relationship between the flat electrode 50A and the flat electrode 50B. Furthermore, the capacitance C2 between the flat electrode 50C and the flat electrode 50D may be suitably adjusted by changing the relative positional relationship between the flat electrode 50C and the flat electrode 50D.

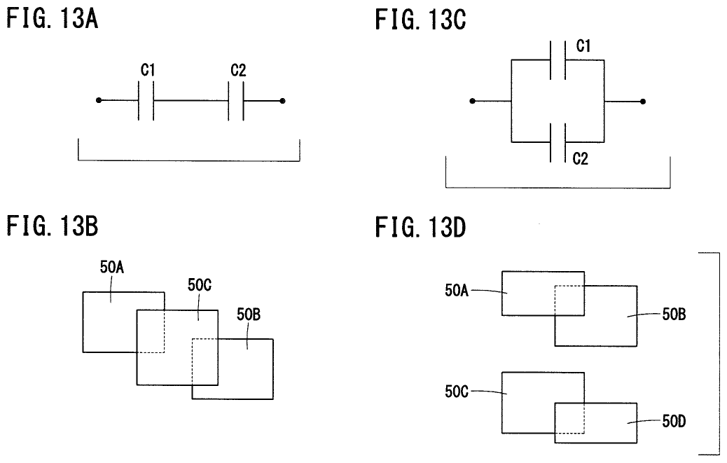

In the capacitive coupling structure 54 described above using FIGS. 11A to 11C, the capacitance between the flat electrodes 50 can be adjusted by relatively shifting the flat electrode 50C in one direction (extension direction of the flat electrode). In the capacitive coupling structure 54 described above using FIGS. 12A and 12B, the capacitance between the flat electrodes 50 can be adjusted by relatively shifting the flat electrodes 50A and 50D in one direction (extension direction of the flat electrodes). The adjustment of the capacitance between the flat electrodes 50 is not limited to the above. As an example, as shown in FIGS. 13A an 13B, the capacitance between flat electrodes 50 may be adjusted by relatively shifting the flat electrode 50C in two directions (the extension direction of the flat electrode and a direction orthogonal thereto). In the example of FIGS. 13A and 13B, one end of the flat electrode 50C overlaps with at least one corner portion of the flat electrode 50A in the planar view. Furthermore, in the example of FIGS. 13A and 13B, the other end of the flat electrode 50C overlaps with at least one corner portion of the flat electrode 50B in the planar view.

As shown in FIGS. 13C and 13D, the capacitance between flat electrodes 50 may be adjusted by relatively shifting the flat electrode 50A and flat electrode 50B in two directions (the extension direction of the flat electrodes and a direction orthogonal thereto). Furthermore, the capacitance between flat electrodes 50 may be adjusted by relatively shifting the flat electrode 50C and flat electrode 50D in two directions (the extension direction of the flat electrodes and a direction orthogonal thereto). The flat electrode 50C and the flat electrode 50D may be relatively shifted in the two directions while also relatively shifting the flat electrode 50A and the flat electrode 50B in the two direction. In the example shown in FIGS. 13C and 13D, the flat electrode 50A overlaps with at least one corner portion of the flat electrode 50B in the planar view. Furthermore, in the example shown in FIGS. 13C and 13D, the flat electrode 50D overlaps with at least one corner portion of the flat electrode 50C in the planar view.

### Third Embodiment Example

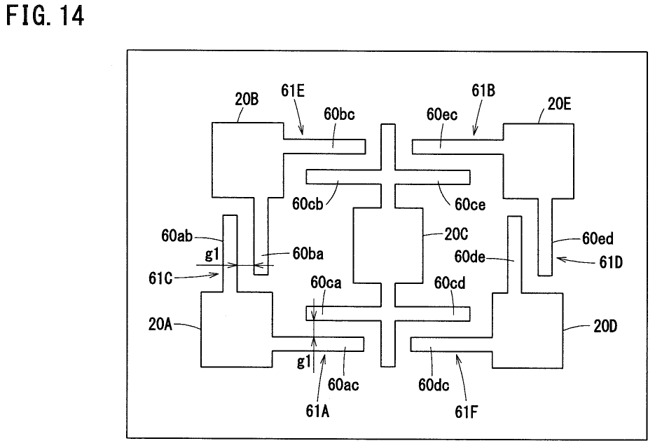

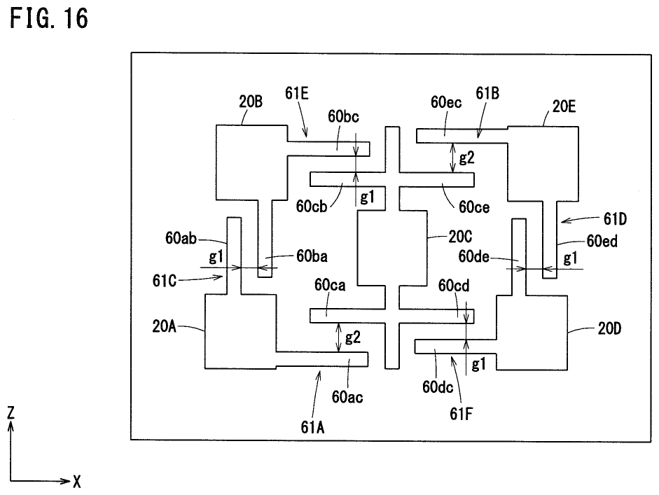

As shown in FIG. 14, the filter according to Comparative Example 3 includes capacitive electrodes 60ab, 60ac, 60ba, and 60bc. Furthermore, as shown in FIG. 16, the filter according to Embodiment Example 3 includes capacitive electrodes 60ab, 60ac, 60ba, and 60bc. The via electrode portion 20A includes the capacitive electrode 60ab that extends toward the via electrode portion 20B and the capacitive electrode 60ac that extends toward the via electrode portion 20C. The via electrode portion 20B includes the capacitive electrode 60ba that extends toward the via electrode portion 20A and the capacitive electrode 60bc that extends toward the via electrode portion 20C.

As shown in FIG. 14, the filter according to Comparative Example 3 includes capacitive electrodes 60dc, 60de, 60ec, and 60ed. Furthermore, as shown in FIG. 16, the filter according to Embodiment Example 3 includes capacitive electrodes 60dc, 60de, 60ec, and 60ed. The via electrode portion 20D includes the capacitive electrode 60dc that extends toward the via electrode portion 20C and the capacitive electrode 60de that extends toward the via electrode portion 20E. The via electrode portion 20E includes the capacitive electrode 60ec that extends toward the via electrode portion 20C and the capacitive electrode 60ed that extends toward the via electrode portion 20D.

As shown in FIG. 14, the filter according to Comparative Example 3 includes capacitive electrodes 60ca, 60cb, 60cd, and 60ce. Furthermore, as shown in FIG. 16, the filter according to Embodiment Example 3 includes capacitive electrodes 60ca, 60cb, 60cd, and 60ce. The via electrode portion 20C includes the capacitive electrode 60ca that extends toward the via electrode portion 20A, the capacitive electrode 60cb that extends toward the via electrode portion 20B, the capacitive electrode 60cd that extends toward the via electrode portion 20D, and the capacitive electrode 60ce that extends toward the via electrode portion 20E. The reference numeral 60 is used when describing a capacitive electrode in general, and the reference numerals 60ab, 60ac, 60ba, 60bc, 60dc, 60de, 60ec, 60ed, 60ca, 60cb, 60cd, 60ce are used when describing specific capacitive electrodes. Capacitive electrodes 60 that are near each other are capacitively coupled. A capacitive coupling structure 61A is formed by the capacitive electrode 60ac and capacitive electrode 60ca that are near each other. A capacitive coupling structure 61B is formed by the capacitive electrode 60ec and capacitive electrode 60ce that are near each other. A capacitive coupling structure 61C is formed by the capacitive electrode 60ab and capacitive electrode 60ba that are near each other. A capacitive coupling structure 61D is formed by the capacitive electrode 60de and capacitive electrode 60ed that are near each other. A capacitive coupling structure 61E is formed by the capacitive electrode 60bc and capacitive electrode 60cb that are near each other. A capacitive coupling structure 61F is formed by the capacitive electrode 60cd and capacitive electrode 60dc that are near each other.

### Comparative Example 3

As shown in FIG. 14, in Comparative Example 3, each distance g1 between a pair of capacitive electrodes 60 (distance in a direction orthogonal to the extension direction of the capacitive electrodes 60) is set to be the same, regardless of the sensitivity of the elements forming the filter. That is, in the filter according to Comparative Example 3, the distance g1 between respective capacitive electrodes 60 is set to be the same regardless of the degree of coupling between the resonators 11. In Comparative Example 3, the sensitivity between the capacitive electrode 60ac and the capacitive electrode 60ca is relatively high. That is, in Comparative Example 3, the degree of coupling between the resonator 11A and the resonator 11C is relatively high. Furthermore, in Comparative Example 3, the sensitivity between the capacitive electrode 60ec and the capacitive electrode 60ce is relatively high. That is, the degree of coupling between the resonator 11C and the resonator 11E is relatively high.

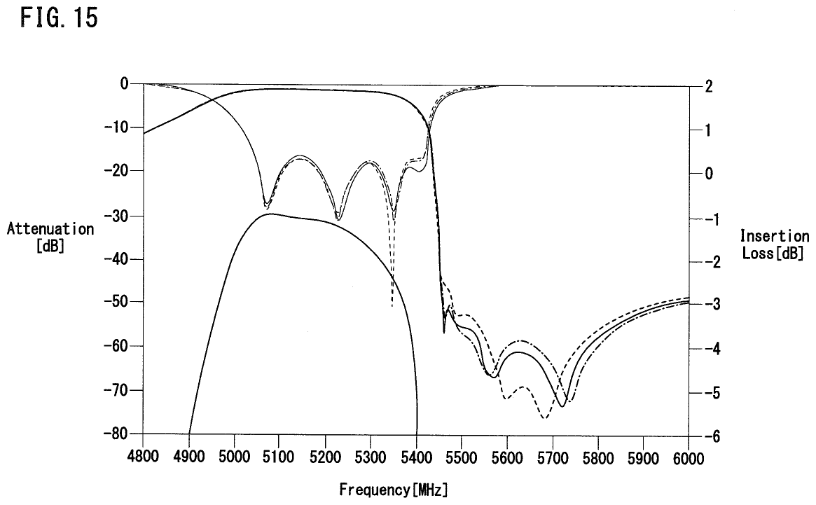

As shown in FIG. 15, the frequency characteristics of the filter according to Comparative Example 3 were such that there was large variation in the attenuation characteristic in the high-frequency region.

### Embodiment Example 3

As shown in FIG. 16, in Embodiment Example 3, the distances between pairs of capacitive electrodes 60 were suitably set according to the sensitivity of the elements forming the filter 10. That is, in Embodiment Example 3, the distances between pairs of capacitive electrodes 60 were suitably set according to the degree of coupling between resonators 11. In FIG. 16, the distance g2 between the capacitive electrode 60ac and the capacitive electrode 60ca and the distance g2 between the capacitive electrode 60ec and capacitive electrode 60ce were set to be greater than the distance g1 between other pairs of capacitive electrodes 60. That is, in Embodiment Example 3, the distance g2 between the capacitive electrodes 60 in the capacitive coupling structures 61A and 61B was set to be greater than the distance g1 between the capacitive electrodes 60 in the capacitive coupling structures 61C to 61F.

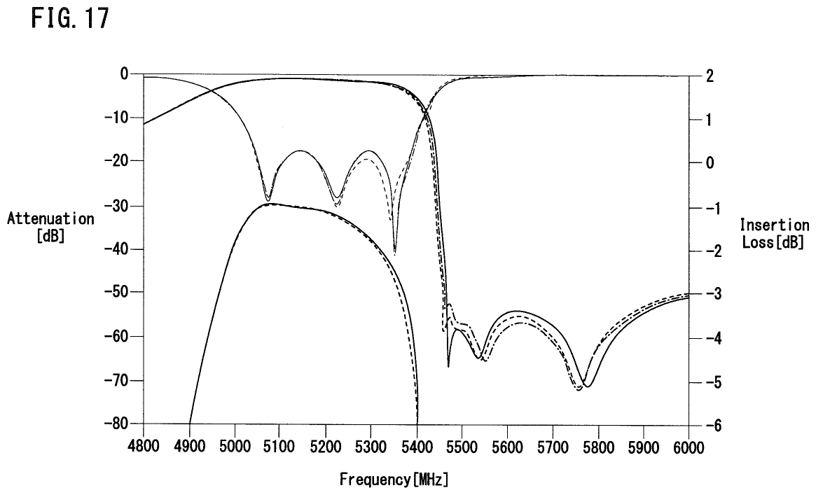

As a result, as shown in FIG. 17, the frequency characteristics of the filter according to Embodiment Example 3 were such excellent, and there was very little variation in the attenuation characteristic in the high-frequency region. That is, the filter according to Embodiment Example 3 can reduce the variation in the attenuation characteristic.

In this way, in the present embodiment, it is possible to restrict the variation in the degree of coupling between resonators 11 by arranging the resonator 11A that is closest to the input/output terminal 22A and the resonator 11E that is closest to the input/output terminal 22B to be at positions having point symmetry.

As an example, as shown in FIG. 2, in the case of a five-stage filter, the first-stage resonator 11A and the fifth-stage resonator 11E are arranged at positions having point symmetry with respect to the center of the dielectric substrate 14C, in the planar view.

Furthermore, the structures of the coupling capacitances and jump capacitances are formed not by the flat electrodes facing each other, but by sandwiching the flat electrode by the flat electrodes 50 formed in two layers and connecting them in series, thereby making it possible to restrict the variation.

The distance between capacitive electrodes 60 formed in the same layer is set to be a suitable distance according to the sensitivity of the elements forming the filter, and therefore it is possible to reduce the variation in the filter characteristics.

### Second Embodiment

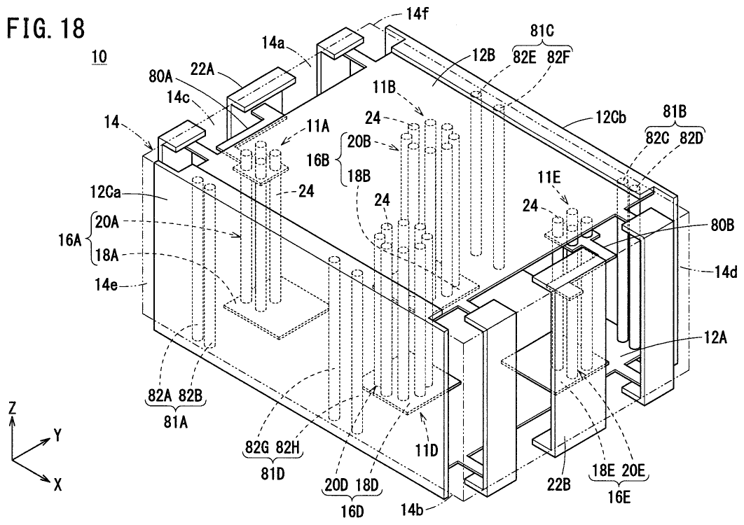

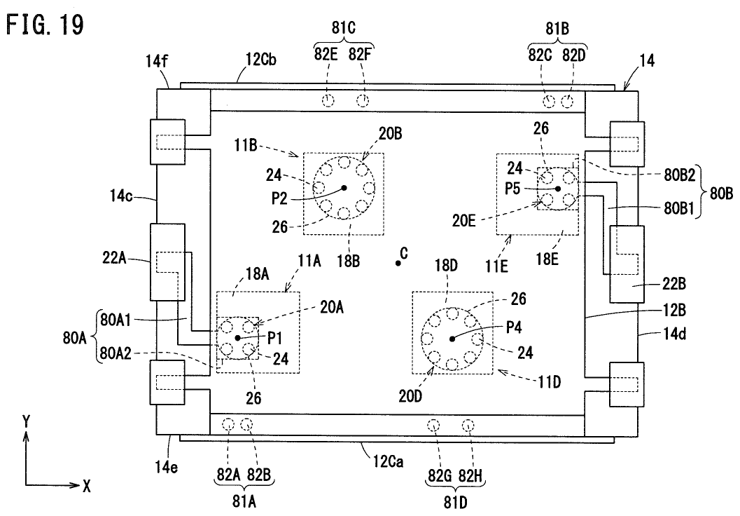

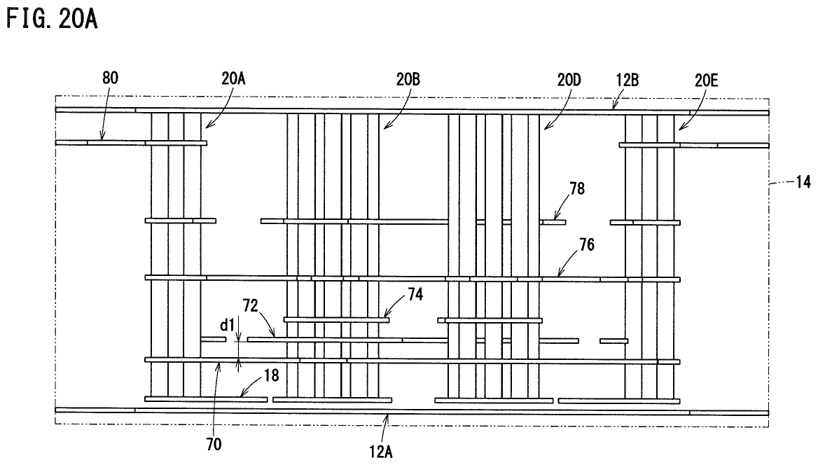

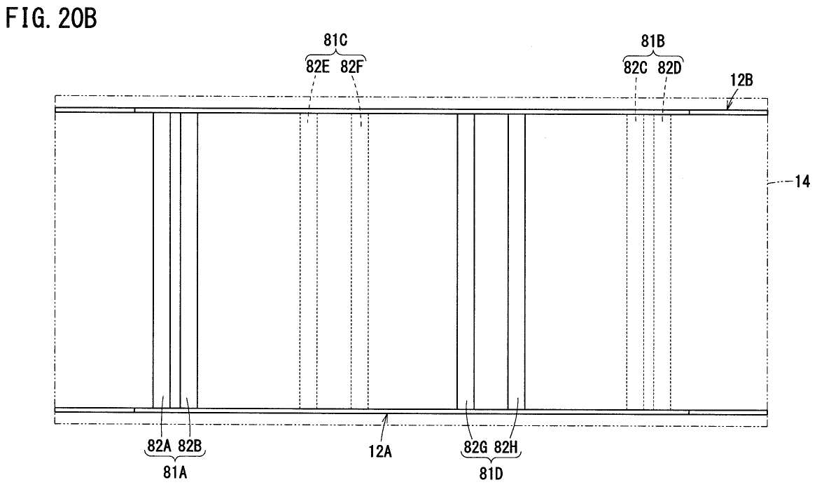

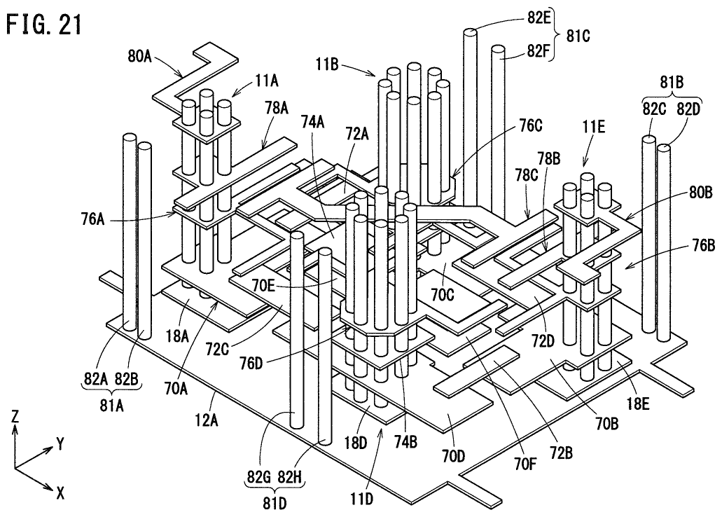

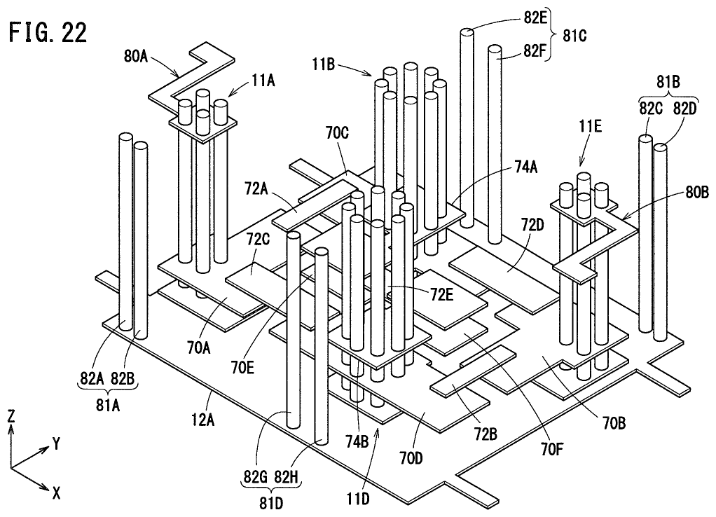

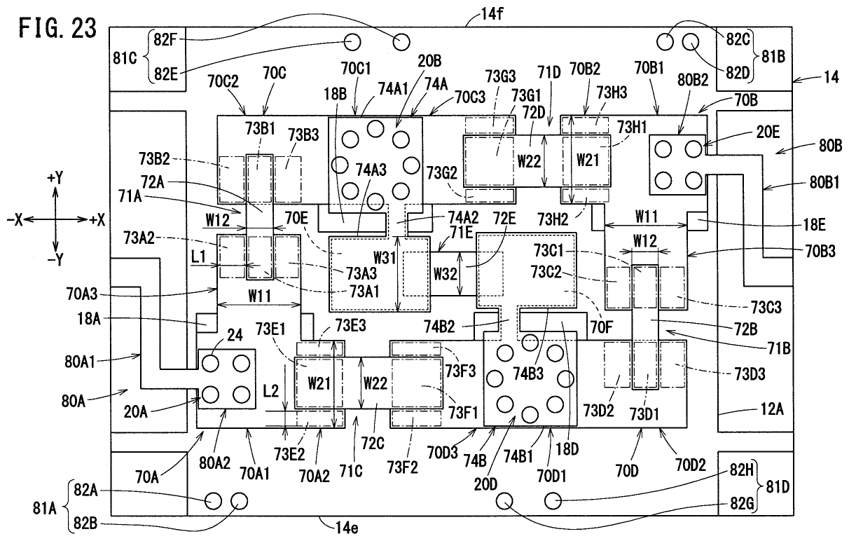

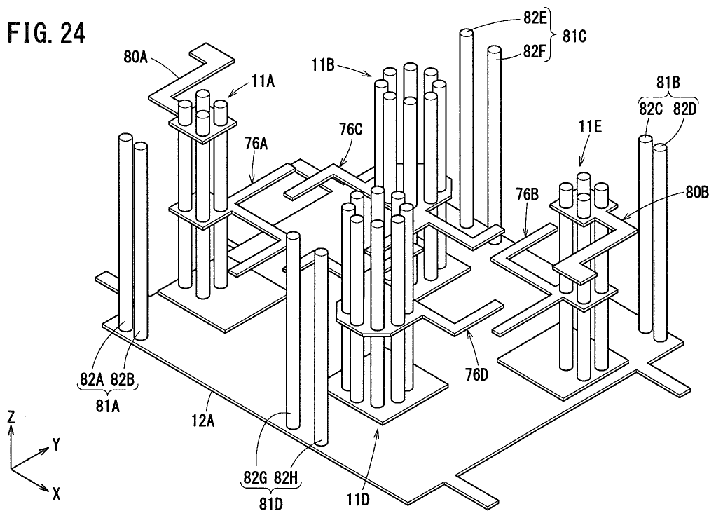

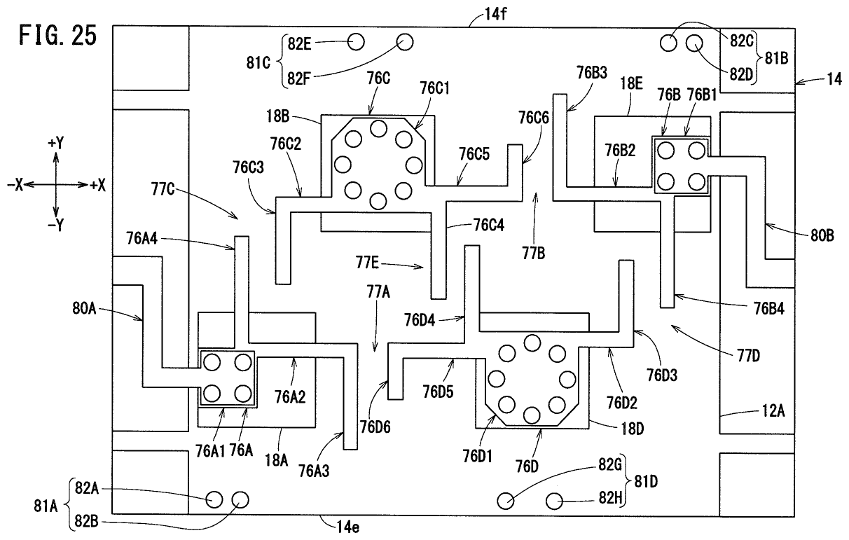

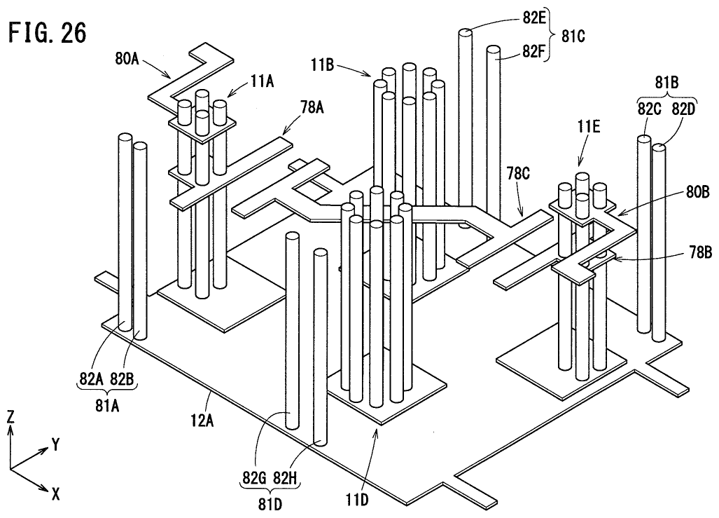

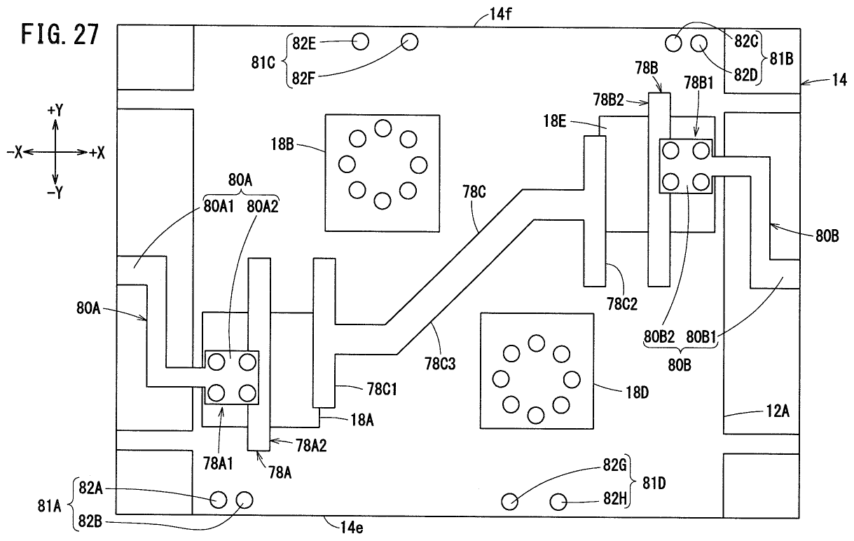

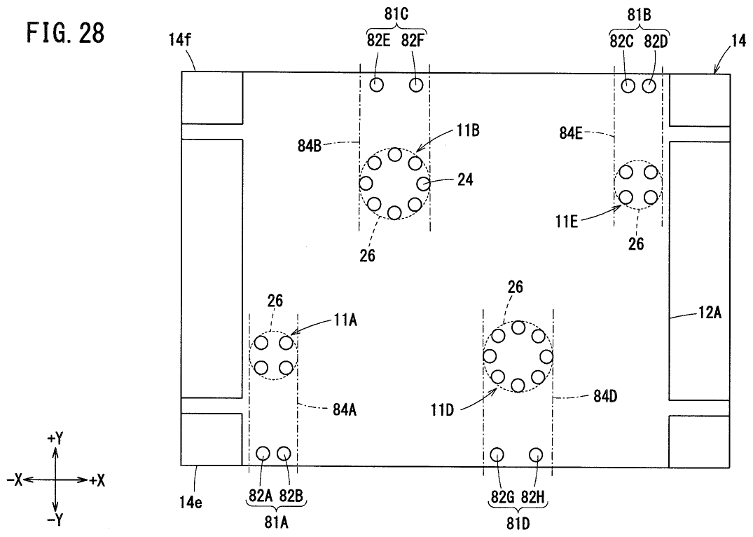

The following describes a filter according to a second embodiment. FIG. 18 is a perspective view showing the filter according to the present embodiment. FIG. 19 is a planar view showing the filter according to the present embodiment. FIGS. 20A and 20B are each a cross-sectional view showing part of the filter according to the present embodiment. FIGS. 21 and 22 are each a perspective view showing the filter according to the present embodiment. FIG. 23 is a planar view showing the filter according to the present embodiment. FIG. 24 is a perspective view showing the filter according to the present embodiment. FIG. 25 is a planar view showing the filter according to the present embodiment. FIG. 26 is a perspective view showing the filter according to the present embodiment. FIGS. 27 and 28 are each a planar view showing the filter according to the present embodiment. For the sake of simplicity, some configurational elements are omitted from FIGS. 18 to 28.

The filter 10 according to the present embodiment includes four resonators 11. Specifically, the filter 10 according to the present embodiment includes a resonator 11A, a resonator 11B, a resonator 11D, and a resonator 11E. The filter 10 according to the present embodiment does not include the resonator 11C (see FIG. 1).

The resonator (first resonator) 11A and the resonator (second resonator) 11E are arranged at positions having point symmetry, with the center C of the dielectric substrate 14 in the planar view being the center of symmetry. The resonator (third resonator) 11B and the resonator (fourth resonator) 11D are arranged at positions having point symmetry, with the center C of the dielectric substrate 14 in the planar view being the center of symmetry.

The position of the resonator 11B in the X direction is between the position of the resonator 11A in the X direction and the center C of the dielectric substrate 14 in the X direction.

The position of the resonator 11D in the X direction is between the position of the resonator 11E in the X direction and the center C of the dielectric substrate 14 in the X direction.

The resonator 11A and resonator 11B are arranged to be adjacent to each other. The resonator 11B and resonator 11D are arranged to be adjacent to each other. The resonator 11D and resonator 11E are arranged to be adjacent to each other.

As shown in FIG. 19, the via electrode portion 20A, via electrode portion 20B, via electrode portion 20D, and via electrode portion 20E are shifted relative to each other in the X direction. The position of the center P2 of the via electrode portion 20B in the X direction is between the position of the center P1 of the via electrode portion 20A in the X direction and the position of the center P4 of the via electrode portion 20D in the X direction. The position of the center P4 of the via electrode portion 20D in the X direction is between the position of the center P2 of the via electrode portion 20B in the X direction and the position of the center P5 of the via electrode portion 20E in the X direction.

The position of the center P1 of the via electrode portion 20A in the Y direction and the position of the center P4 of the via electrode portion 20D in the Y direction are the same. The position of the center P2 of the via electrode portion 20B in the Y direction and the position of the center P5 of the via electrode portion 20E in the Y direction are the same. The via electrode portion 20B and via electrode portion 20E are shifted in the Y direction relative to the via electrode portion 20A and via electrode portion 20D. The via electrode portion 20A and via electrode portion 20D are positioned on the side surface 14e side. Specifically, the distance between the via electrode portions 20A and 20D and the shield conductor 12Ca is less than the distance between the via electrode portions 20A and 20D and the shield conductor 12Cb. The via electrode portions 20B and 20E are positioned on the side surface 14f side. Specifically, the distance between the via electrode portions 20B and 20E and the shield conductor 12Cb is less than the distance between the via electrode portions 20B and 20E and the shield conductor 12Ca.

In this way, in the present embodiment, the position of the center P1 of the via electrode portion 20A and the position of the center P2 of the via electrode portion 20B are shifted from each other not only in the X direction, but also in the Y direction. Therefore, according to the present embodiment, it is possible to increase the distance between the via electrode portions 20A and 20B without increasing the distance between the via electrode portions 20A and 20B in the X direction. Furthermore, according to the present embodiment, the position of the center P2 of the via electrode portion 20B and the position of the center P4 of the via electrode portion 20D are shifted from each other not only in the X direction, but also in the Y direction. Therefore, according to the present embodiment, it is possible to increase the distance between the via electrode portions 20B and 20D without increasing the distance between the via electrode portions 20B and 20D in the X direction. According to the present embodiment, the position of the center P4 of the via electrode portion 20D and the position of the center P5 of the via electrode portion 20E are shifted from each other not only in the X direction, but also in the Y direction. Therefore, according to the present embodiment, it is possible to increase the distance between the via electrode portions 20D and 20E without increasing the distance between the via electrode portions 20D and 20E in the X direction. In this way, according to the present embodiment, it is possible to reduce the degree of coupling between adjacent resonators 11 without increasing the distance in the X direction between adjacent resonators 11. Accordingly, with the present embodiment, it is possible to realize a filter 10 with excellent characteristics, while keeping the size of the filter 10 small.

Among the four via electrode portions 20A, 20B, 20D, and 20E, the via electrode portion 20 closest to the input/output terminal 22A is the via electrode portion 20A. The distance in the X direction between the position of the center P1 of the via electrode portion 20A and the position of the input/output terminal 22A is less than the distance in the X direction between the center P2 of the via electrode portion 20B and the position of the input/output terminal 22A. The distance in the Y direction between the position of the center P1 of the via electrode portion 20A and the position of the input/output terminal 22A is equal to the distance in the Y direction between the position of the center P2 of the via electrode portion 20B and the position of the input/output terminal 22A.

Among the four via electrode portions 20A, 20B, 20D, and 20E, the via electrode portion 20 closest to the input/output terminal 22B is the via electrode portion 20E. The distance in the X direction between the position of the center P5 of the via electrode portion 20E and the position of the input/output terminal 22B is less than the distance in the X direction between the center P4 of the via electrode portion 20D and the position of the input/output terminal 22B. The distance in the Y direction between the position of the center P5 of the via electrode portion 20E and the position of the input/output terminal 22B is equal to the distance in the Y direction between the position of the center P4 of the via electrode portion 20D and the position of the input/output terminal 22B.

The resonators 11A, 11B, 11D, and 11E are arranged at positions having point symmetry, with the center C of the dielectric substrate 14 in the planar view being the center of symmetry. Specifically, the resonator 11A and the resonator 11E are arranged at positions having point symmetry, with the center C of the dielectric substrate 14 in the planar view as the center of symmetry. Furthermore, the resonator 11B and the resonator 11D are arranged at positions having point symmetry, with the center C of the dielectric substrate 14 in the planar view as the center of symmetry. In the present embodiment, the reason for arranging the resonators 11A, 11B, 11D, and 11E with point symmetry is in order to realize excellent frequency characteristics.

The positions in the Y direction of the center P1 of the via electrode portion 20A and the center P4 of the via electrode portion 20D are on the side surface 14e side of the position in the Y direction of the center C of the dielectric substrate 14. The positions in the Y direction of the center P2 of the via electrode portion 20B and the center P5 of the via electrode portion 20E are on the side surface 14f side of the position in the Y direction of the center C of the dielectric substrate 14. The positions in the Y direction of the center of the input/output terminal 22A and the center of the input/output terminal 22B are set to be the same as the position in the Y direction of the center C of the dielectric substrate 14.

As shown in FIG. 22, capacitive coupling electrodes (flat electrodes) 70A to 70F are formed within the dielectric substrate 14. The capacitive coupling electrode 70A is provided to the resonator 11A. The capacitive coupling electrode 70B is provided to the resonator 11E. The capacitive coupling electrode 70C is provided to the resonator 11B. The capacitive coupling electrode 70D is provided to the resonator 11D. The capacitive coupling electrodes 70E and 70F are provided near the center C of the dielectric substrate 14 in the planar view (see FIG. 19). The capacitive coupling electrodes 70A to 70F are formed in the same layer. In other words, the capacitive coupling electrodes 70A to 70F are formed on the same ceramic sheet (not shown). The reference numeral 70 is used for descriptions that do not distinguish among individual capacitive coupling electrodes, and the reference numerals 70A to 70F are used for descriptions that distinguish among individual capacitive coupling electrodes. One or more ceramic sheets (not shown) are provided between the capacitive coupling electrodes 70 and the capacitor electrode 18. The capacitive coupling electrodes 70 can be formed by printing, for example.

The capacitive coupling electrodes 70 are arranged at positions having point symmetry, with the center C of the dielectric substrate 14 in the planar view being the center of symmetry. Specifically, the capacitive coupling electrode 70A and capacitive coupling electrode 70B are arranged at positions having point symmetry, with the center C of the dielectric substrate 14 in the planar view being the center of symmetry. Furthermore, the capacitive coupling electrode 70C and capacitive coupling electrode 70D are arranged at positions having point symmetry, with the center C of the dielectric substrate 14 in the planar view being the center of symmetry. Yet further, the capacitive coupling electrode 70E and capacitive coupling electrode 70F are arranged at positions having point symmetry, with the center C of the dielectric substrate 14 in the planar view being the center of symmetry. In the present embodiment, the reason for arranging the capacitive coupling electrodes 70 with point symmetry is to make it possible to realize excellent frequency characteristics.

The capacitive coupling electrode 70A is connected to the via electrode portion 20A. The bottom surface of the capacitive coupling electrode 70A is connected to the top surface of the capacitor electrode 18A, via part of the via electrode portion 20A.

The capacitive coupling electrode 70B is connected to the via electrode portion 20E. The bottom surface of the capacitive coupling electrode 70B is connected to the top surface of the capacitor electrode 18E, via part of the via electrode portion 20E.

The capacitive coupling electrode 70C is connected to the via electrode portion 20B. The bottom surface of the capacitive coupling electrode 70C is connected to the top surface of the capacitor electrode 18B, via part of the via electrode portion 20B.

The capacitive coupling electrode 70D is connected to the via electrode portion 20D. The bottom surface of the capacitive coupling electrode 70D is connected to the top surface of the capacitor electrode 18D, via part of the via electrode portion 20D.

As shown in FIG. 23, the capacitive coupling electrode 70A includes partial patterns (electrode patterns) 70A1 to 70A3. The partial pattern 70A1 is connected to the via electrode portion 20A. One end of the partial pattern 70A2 is connected to the partial pattern 70A1. The partial pattern 70A2 protrudes in the +X direction. One end of the partial pattern 70A3 is connected to the partial pattern 70A1. The partial pattern 70A3 protrudes in the +Y direction.

The capacitive coupling electrode 70B includes partial patterns 70B1 to 70B3. The partial pattern 70B1 is connected to the via electrode portion 20E. One end of the partial pattern 70B2 is connected to the partial pattern 70B1. The partial pattern 70B2 protrudes in the −X direction. One end of the partial pattern 70B3 is connected to the partial pattern 70B1. The partial pattern 70B3 protrudes in the −Y direction.

The capacitive coupling electrode 70C includes partial patterns 70C1 to 70C3. The partial pattern 70C1 is connected to the via electrode portion 20B. One end of the partial pattern 70C2 is connected to the partial pattern 70C1. The partial pattern 70C2 protrudes in the −X direction. One end of the partial pattern 70C3 is connected to the partial pattern 70C1. The partial pattern 70C3 protrudes in the +X direction.

The capacitive coupling electrode 70D includes partial patterns 70D1 to 70D3. The partial pattern 70D1 is connected to the via electrode portion 20D. One end of the partial pattern 70D2 is connected to the partial pattern 70D1. The partial pattern 70D2 protrudes in the +X direction. One end of the partial pattern 70D3 is connected to the partial pattern 70D1. The partial pattern 70D3 protrudes in the −X direction.

The position in the Y direction of the capacitive coupling electrode 70E is between the positions in the Y direction of the capacitive coupling electrodes 70A and 70D and the positions in the Y direction of the capacitive coupling electrodes 70B and 70C. The position in the X direction of the capacitive coupling electrode 70E is between the position in the X direction of the partial pattern 70A3 provided to the capacitive coupling electrode 70A and the position in the X direction of the capacitive coupling electrode 70F. The capacitive coupling electrode 70E is connected to the capacitive coupling electrode 70C.

The position in the Y direction of the capacitive coupling electrode 70F is between the positions in the Y direction of the capacitive coupling electrodes 70A and 70D and the positions in the Y direction of the capacitive coupling electrodes 70B and 70C. The position in the X direction of the capacitive coupling electrode 70F is between the position in the X direction of the partial pattern 70B3 provided to the capacitive coupling electrode 70B and the position in the X direction of the capacitive coupling electrode 70E. The capacitive coupling electrode 70F is connected to the capacitive coupling electrode 70D.

As shown in FIG. 22, capacitive coupling electrodes (flat electrodes) 72A to 72E are also formed within the dielectric substrate 14. The capacitive coupling electrodes 72A to 72E are formed in the same layer. In other words, the capacitive coupling electrodes 72A to 72E are formed on the same ceramic sheet (not shown). The reference numeral 72 is used for descriptions that do not distinguish among individual capacitive coupling electrodes, and the reference numerals 72A to 72E are used for descriptions that distinguish among individual capacitive coupling electrodes. One or more ceramic sheets (not shown) are provided between the capacitive coupling electrodes 72 and the capacitive coupling electrodes 70. The capacitive coupling electrodes 72 can be formed by printing, for example.

The capacitive coupling electrodes 72 are arranged at positions having point symmetry, with the center C of the dielectric substrate 14 in the planar view being the center of symmetry (see FIG. 19). Specifically, the capacitive coupling electrode 72A and capacitive coupling electrode 72B are arranged having point symmetry, with the center C of the dielectric substrate 14 in the planar view being the center of symmetry. Furthermore, the capacitive coupling electrode 72C and capacitive coupling electrode 72D are arranged having point symmetry, with the center C of the dielectric substrate 14 in the planar view being the center of symmetry. In the present embodiment, the reason for arranging the capacitive coupling electrodes 72 with point symmetry is that it becomes possible to realize excellent frequency characteristics.

As shown in FIG. 23, the longitudinal direction of the capacitive coupling electrode 72A is the Y direction. One end of the capacitive coupling electrode 72A overlaps with the capacitive coupling electrode 70A in the planar view. More specifically, one end of the capacitive coupling electrode 72A overlaps with the partial pattern 70A3 in the planar view. The other end of the capacitive coupling electrode 72A overlaps with the capacitive coupling electrode 70C in the planar view. More specifically, the other end of the capacitive coupling electrode 72A overlaps with the partial pattern 70C2 in the planar view. A capacitive coupling structure 71A is formed by the capacitive coupling electrode 70A, capacitive coupling electrode 72A, and capacitive coupling electrode 70C.

The longitudinal direction of the capacitive coupling electrode 72B is the Y direction. One end of the capacitive coupling electrode 72B overlaps with the capacitive coupling electrode 70D in the planar view. More specifically, one end of the capacitive coupling electrode 72B overlaps with the partial pattern 70D2 in the planar view. The other end of the capacitive coupling electrode 72B overlaps with the capacitive coupling electrode 70B in the planar view. More specifically, the other end of the capacitive coupling electrode 72B overlaps with the partial pattern 70B3 in the planar view. A capacitive coupling structure 71B is formed by the capacitive coupling electrode 70B, capacitive coupling electrode 72B, and capacitive coupling electrode 70D.

The longitudinal direction of the capacitive coupling electrode 72C is the X direction. One end of the capacitive coupling electrode 72C overlaps with the capacitive coupling electrode 70A in the planar view. More specifically, one end of the capacitive coupling electrode 72C overlaps with the partial pattern 70A2 in the planar view. The other end of the capacitive coupling electrode 72C overlaps with the capacitive coupling electrode 70D in the planar view. More specifically, the other end of the capacitive coupling electrode 72C overlaps with the partial pattern 70D3 in the planar view. A capacitive coupling structure 71C is formed by the capacitive coupling electrode 70A, capacitive coupling electrode 72C, and capacitive coupling electrode 70D. The via electrode portion 20A and the via electrode portion 20D are positioned on the extension region of the capacitive coupling electrode 72C. Specifically, the via electrode portion 20A is positioned on the extension region at one end of the capacitive coupling electrode 72C, and the via electrode portion 20D is positioned on the extension region at the other end of the capacitive coupling electrode 72C.

The longitudinal direction of the capacitive coupling electrode 72D is the X direction. One end of the capacitive coupling electrode 72D overlaps with the capacitive coupling electrode 70B in the planar view. More specifically, one end of the capacitive coupling electrode 72D overlaps with the partial pattern 70B2 in the planar view. The other end of the capacitive coupling electrode 72D overlaps with the capacitive coupling electrode 70C in the planar view. More specifically, the other end of the capacitive coupling electrode 72D overlaps with the partial pattern 70C3 in the planar view. A capacitive coupling structure 71D is formed by the capacitive coupling electrode 70B, capacitive coupling electrode 72D, and capacitive coupling electrode 70C. The via electrode portion 20B and the via electrode portion 20E are positioned on the extension region of the capacitive coupling electrode 72D. Specifically, the via electrode portion 20E is positioned on the extension region at one end of the capacitive coupling electrode 72D, and the via electrode portion 20B is positioned on the extension region at the other end of the capacitive coupling electrode 72C.

The longitudinal direction of the capacitive coupling electrode 72E is the X direction. One end of the capacitive coupling electrode 72E overlaps with the capacitive coupling electrode 70E in the planar view. The other end of the capacitive coupling electrode 72E overlaps with the capacitive coupling electrode 70F in the planar view.

An inter-electrode distance d1 (see FIG. 20A) between the capacitive coupling electrode 72 and the capacitive coupling electrode 70 in the thickness direction of the capacitive coupling electrode 72 is approximately 0.12 mm, for example, but is not limited to this. The inter-electrode distance d1 may be 0.06 mm, for example, but is not limited to this value.

The dimension W12 of the capacitive coupling electrode 72A in the width direction (X direction) of the capacitive coupling electrode 72A is less than the dimension W11 of the partial pattern 70A3 in the width direction of the capacitive coupling electrode 72A. That is, the dimension W12 of the capacitive coupling electrode 72A in the X direction is less than the dimension W11 of the partial pattern 70A3 in the X direction. There are regions (locations) 73A2 and 73A3 where the capacitive coupling electrode 72A and partial pattern 70A3 do not overlap, on both sides of a region (location) 73A1 where the capacitive coupling electrode 72A and partial pattern 70A3 overlap in the planar view. The region 73A2 is positioned on the −X side of the region 73A1. The region 73A3 is positioned on the +X side of the region 73A1. The dimension W11 of the partial pattern 70A3 in the width direction of the capacitive coupling electrode 72A is set to be 0.54 mm, for example. The dimension W12 of the capacitive coupling electrode 72A in the width direction of the capacitive coupling electrode 72A is set to be 0.18 mm, for example.

The dimension W12 of the capacitive coupling electrode 72A in the width direction of the capacitive coupling electrode 72A is less than the dimension of the partial pattern 70C2 in the width direction of the capacitive coupling electrode 72A. Specifically, the width W12 of the capacitive coupling electrode 72A in the X direction is less than the dimension of the partial pattern 70C2 in the X direction. There are regions 73B2 and 73B3 where the capacitive coupling electrode 72A and partial pattern 70C2 do not overlap, on both sides of a region 73B1 where the capacitive coupling electrode 72A and partial pattern 70C2 overlap in the planar view. The region 73B2 is positioned on the −X side of the region 73B1. The region 73B3 is positioned on the +X side of the region 73B1.

The dimension W12 of the capacitive coupling electrode 72B in the width direction (X direction) of the capacitive coupling electrode 72B is less than the dimension W11 of the partial pattern 70B3 in the width direction of the capacitive coupling electrode 72B. That is, the dimension W12 of the capacitive coupling electrode 72B in the X direction is less than the dimension W11 of the partial pattern 70B3 in the X direction. There are regions 73C2 and 73C3 where the capacitive coupling electrode 72B and partial pattern 70B3 do not overlap, on both sides of a region 73C1 where the capacitive coupling electrode 72B and partial pattern 70B3 overlap in the planar view. The region 73C2 is positioned on the −X side of the region 73C1. The region 73C3 is positioned on the +X side of the region 73C1. The dimension W11 of the partial pattern 70B3 in the width direction of the capacitive coupling electrode 72B is set to be 0.54 mm, for example. The dimension W12 of the capacitive coupling electrode 72B in the width direction of the capacitive coupling electrode 72B is set to be 0.18 mm, for example.

The dimension W12 of the capacitive coupling electrode 72B in the width direction of the capacitive coupling electrode 72B is less than the dimension W11 of the partial pattern 70D2 in the width direction of the capacitive coupling electrode 72B. Specifically, the width W12 of the capacitive coupling electrode 72B in the X direction is less than the dimension W11 of the partial pattern 70D2 in the X direction. There are regions 73D2 and 73D3 where the capacitive coupling electrode 72B and partial pattern 70D2 do not overlap, on both sides of a region 73D1 where the capacitive coupling electrode 72B and partial pattern 70D2 overlap in the planar view. The region 73D2 is positioned on the −X side of the region 73D1. The region 73D3 is positioned on the +X side of the region 73D1.

The dimension W22 of the capacitive coupling electrode 72C in the width direction (Y direction) of the capacitive coupling electrode 72C is less than the dimension W21 of the partial pattern 70A2 in the width direction of the capacitive coupling electrode 72C. That is, the dimension W22 of the capacitive coupling electrode 72C in the Y direction is less than the dimension W21 of the partial pattern 70A2 in the Y direction. There are regions 73E2 and 73E3 where the capacitive coupling electrode 72C and partial pattern 70A2 do not overlap, on both sides of a region 73E1 where the capacitive coupling electrode 72C and partial pattern 70A2 overlap in the planar view. The region 73E2 is positioned on the −Y side of the region 73E1. The region 73E3 is positioned on the +Y side of the region 73E1. The dimension W21 of the partial pattern 70A2 in the width direction of the capacitive coupling electrode 72C is set to be 0.56 mm, for example. The dimension W22 of the capacitive coupling electrode 72C in the width direction of the capacitive coupling electrode 72C is set to be 0.34 mm, for example.

The dimension W22 of the capacitive coupling electrode 72C in the width direction of the capacitive coupling electrode 72C is less than the dimension W21 of the partial pattern 70D3 in the width direction of the capacitive coupling electrode 72C. That is, the dimension W22 of the capacitive coupling electrode 72C in the Y direction is less than the dimension W21 of the partial pattern 70D3 in the Y direction. There are regions 73F2 and 73F3 where the capacitive coupling electrode 72C and partial pattern 70D3 do not overlap, on both sides of a region 73F1 where the capacitive coupling electrode 72C and partial pattern 70D3 overlap in the planar view. The region 73F2 is positioned on the −Y side of the region 73F1. The region 73F3 is positioned on the +Y side of the region 73F1. The dimension W21 of the partial pattern 70D3 in the width direction of the capacitive coupling electrode 72C is set to be 0.56 mm, for example.

The dimension W22 of the capacitive coupling electrode 72D in the width direction (Y direction) of the capacitive coupling electrode 72D is less than the dimension W21 of the partial pattern 70C3 in the width direction of the capacitive coupling electrode 72D. That is, the dimension W22 of the capacitive coupling electrode 72D in the Y direction is less than the dimension W21 of the partial pattern 70C3 in the Y direction. There are regions 73G2 and 73G3 where the capacitive coupling electrode 72D and partial pattern 70C3 do not overlap, on both sides of a region 73G1 where the capacitive coupling electrode 72D and partial pattern 70C3 overlap in the planar view. The region 73G2 is positioned on the −Y side of the region 73G1. The region 73G3 is positioned on the +Y side of the region 73G1. The dimension W21 of the partial pattern 70C3 in the width direction of the capacitive coupling electrode 72D is set to be 0.56 mm, for example. The dimension W22 of the capacitive coupling electrode 72D in the width direction of the capacitive coupling electrode 72D is set to be 0.34 mm, for example.

The dimension W22 of the capacitive coupling electrode 72D in the width direction of the capacitive coupling electrode 72D is less than the dimension W21 of the partial pattern 70B2 in the width direction of the capacitive coupling electrode 72D. That is, the dimension W22 of the capacitive coupling electrode 72D in the Y direction is less than the dimension W21 of the partial pattern 70B2 in the Y direction. There are regions 73H2 and 73H3 where the capacitive coupling electrode 72D and partial pattern 70B2 do not overlap, on both sides of a region 73H1 where the capacitive coupling electrode 72D and partial pattern 70B2 overlap in the planar view. The region 73H2 is positioned on the −Y side of the region 73H1. The region 73H3 is positioned on the +Y side of the region 73H1. The dimension W21 of the partial pattern 70B2 in the width direction of the capacitive coupling electrode 72D is set to be 0.56 mm, for example.

A dimension difference ΔW1, which is a value that can be obtained by subtracting the dimension W12 of the capacitive coupling electrodes 72A and 72B in the width direction of the capacitive coupling electrodes 72A and 72B from the dimension W11 of the partial patterns 70A3 and 70B3 in the width direction of the capacitive coupling electrodes 72A and 72B, is preferably greater than or equal to 1.4 times the inter-electrode distance d1. The dimension difference ΔW1, that is, the dimension difference (W11−W12), is preferably greater than or equal to 2.6 times the inter-electrode distance d1. In the present embodiment, the dimension difference ΔW1 is set to be 3 times the inter-electrode distance d1.

Since the dimension difference ΔW1 is set to be relatively large as described above, the dimension L1 in the X direction of the regions 73A2, 73A3, 73B2, 73B3, 73C2, 73C3, 73D2, and 73D3 is relatively large. In a case where the dimension W11 of the partial patterns 70A3 and 70B3 in the width direction of the capacitive coupling electrodes 72A and 72B is 0.54 mm and the dimension W12 of the capacitive coupling electrodes 72A and 72B in the width direction of the capacitive coupling electrodes 72A and 72B is 0.18 mm, the dimension difference ΔW1 is 0.36 mm. In a case where the dimension difference ΔW1 is 0.36 mm, the dimension L1 is 0.18 mm. In this case, the dimension L1 is 1.5 times the inter-electrode distance d1, for example. In this way, in a case where the dimension difference ΔW1 is 3 times the inter-electrode distance d1, the dimension L1 is 1.5 times the inter-electrode distance d1, for example.

A dimension difference ΔW2, which is a value that can be obtained by subtracting the dimension W22 of the capacitive coupling electrodes 72C and 72D in the width direction of the capacitive coupling electrodes 72C and 72D from the dimension W21 of the partial patterns 70A2, 70B2, 70C3, and 70D3 in the width direction of the capacitive coupling electrodes 72C and 72D, is preferably greater than or equal to 1.4 times the inter-electrode distance d1. In the present embodiment, the dimension difference ΔW2, that is, the dimension difference (W21−W22), is preferably greater than or equal to 1.84 times the inter-electrode distance d1.

Since the dimension difference ΔW2 is set to be relatively large as described above, the dimension L2 in the Y direction of the regions 73E2, 73E3, 73F2, 73F3, 73G2, 73G3, 73H2, and 73H3 is relatively large. In a case where the dimension W21 of the partial patterns 70A2, 70B2, 70C3, and 70D3 in the width direction of the capacitive coupling electrodes 72C and 72D is 0.56 mm and the dimension W22 of the capacitive coupling electrodes 72C and 72D in the width direction of the capacitive coupling electrodes 72C and 72D is 0.34 mm, the dimension difference ΔW2 is 0.22 mm. In a case where the dimension difference ΔW2 is 0.22 mm, the dimension L2 is 0.11 mm. In this case, the dimension L2 is 0.92 times the inter-electrode distance d1, for example. In this way, in a case where the dimension difference ΔW2 is 1.84 times the inter-electrode distance d1, the dimension L2 is 0.92 times the inter-electrode distance d1, for example.

The maximum value of misalignment (positional shift) during manufacturing is approximately 0.03 mm, for example. In a case where the maximum value of the positional shift during manufacturing is 0.03 mm, the dimensions L1 and L2 can be set to 0.03 mm, for example. In contrast to this, in the present embodiment, the dimensions L1 and L2 are set to be relatively large. The dimensions L1 and L2 can be set to be relatively large in the present embodiment for the following reason. In a case where a certain amount of positional shift occurs during manufacturing, the electrostatic capacitances of the capacitive coupling structures 71A to 71D fluctuates greatly if the dimensions L1 and L2 are relatively small. When the electrostatic capacitances of the capacitive coupling structures 71A to 71D fluctuates greatly, excellent filter characteristics cannot be realized. In a case where the dimensions L1 and L2 are relatively large, even when a certain amount of positional shift occurs during manufacturing, the electrostatic capacitances of the capacitive coupling structures 71A to 71D barely fluctuate. For such a reason, in the present embodiment, the dimensions L1 and L2 are set to be relatively large.

The dimension L2 is set to be less than the dimension L1 for the following reason. In the interest of restricting fluctuation in the electrostatic capacitance of the capacitive coupling structure 71C caused by positional shift during manufacturing, the dimension L2 is preferably relatively large. If the dimension L2 is set to be relatively large, it is preferable to make the X-direction dimension of the capacitive coupling electrodes 72C and 72D relatively large in order to ensure the area of the regions 73E1, 73F1, 73G1, and 73H1 where the capacitive coupling electrode 72C overlaps with the partial patterns 70A2, 70D3, 70B2, and 70C3 in the planar view. However, if the X-direction dimension of the capacitive coupling electrode 72C is large, the X-direction distance between the capacitive coupling electrode 72C and the via electrode portion 20A becomes short and the X-direction distance between the capacitive coupling electrode 72C and the via electrode portion 20D becomes short. Furthermore, if the X-direction dimension of the capacitive coupling electrode 72D is large, the X-direction distance between the capacitive coupling electrode 72D and the via electrode portion 20B becomes short and the X-direction distance between the capacitive coupling electrode 72D and the via electrode portion 20E becomes short. When the X-direction distance between the capacitive coupling electrode 72C and the via electrode portion 20A is short and the X-direction distance between the capacitive coupling electrode 72C and the via electrode portion 20D is short, there is a concern that there will be a negative effect on the filter characteristics. When the X-direction distance between the capacitive coupling electrode 72D and the via electrode portion 20B is short and the X-direction distance between the capacitive coupling electrode 72D and the via electrode portion 20E is short, there is a concern that there will be a negative effect on the filter characteristics. On the other hand, no via electrode portion 20 is positioned on the extension region of at least one end of the capacitive coupling electrode 72A, 72B. The via electrode portion 20B is arranged at a position on the +X-direction side of the capacitive coupling electrode 72A. Therefore, even though the capacitive coupling electrode 72A extends in the +Y direction, the distance between the capacitive coupling electrode 72A and via electrode portion 20B is not shortened. Furthermore, the via electrode portion 20D is arranged at a position on the −X-direction side of the capacitive coupling electrode 72B. Therefore, even though the capacitive coupling electrode 72B extends in the −Y direction, the distance between the capacitive coupling electrode 72B and via electrode portion 20D is not shortened. No particular problem is caused by extending the capacitive coupling electrode 72A in the +Y direction. No particular problem is caused by extending the capacitive coupling electrode 72B in the −Y direction. Due to these reasons, the dimension L2 is set to be less than the dimension L1.

The dimension of the capacitive coupling electrode 72E in the width direction of the capacitive coupling electrode 72E is less than the dimension of the capacitive coupling electrode 70E in the width direction of the capacitive coupling electrode 72E. That is, the dimension of the capacitive coupling electrode 72E in the Y direction is less than the dimension of the capacitive coupling electrode 70E in the Y direction. The dimension of the capacitive coupling electrode 70E in the width direction of the capacitive coupling electrode 72E is set to be 0.5 mm, for example. The dimension of the capacitive coupling electrode 72E in the width direction of the capacitive coupling electrode 72E is set to be 0.29 mm, for example.

The dimension of the capacitive coupling electrode 72E in the width direction of the capacitive coupling electrode 72E is less than the dimension of the capacitive coupling electrode 70F in the width direction of the capacitive coupling electrode 72E. That is, the dimension of the capacitive coupling electrode 72E in the Y direction is less than the dimension of the capacitive coupling electrode 70F in the Y direction. The dimension of the capacitive coupling electrode 70F in the width direction of the capacitive coupling electrode 72E is set to be 0.5 mm, for example.

A dimension difference ΔW3, which is a value obtained by subtracting the dimension W32 of the capacitive coupling electrode 72E in the width direction of the capacitive coupling electrode 72E from the dimension W31 of the capacitive coupling electrodes 70E and 70F in the width direction of the capacitive coupling electrode 72E, is preferably greater than or equal to 1.4 times the inter-electrode distance d1. In the present embodiment, the dimension difference ΔW3, that is, the dimension difference (W31−W32), is set to be 1.75 times the inter-electrode distance d1.

As shown in FIG. 22, capacitive coupling electrodes (flat electrodes) 74A and 74B are formed within the dielectric substrate 14. The capacitive coupling electrodes 74A and 74B are formed in the same layer. In other words, the capacitive coupling electrodes 74A and 74B are formed on the same ceramic sheet (not shown). The reference numeral 74 is used when describing capacitive coupling electrodes without distinguishing therebetween, and the reference numerals 74A and 74B are used when describing capacitive coupling electrodes while distinguishing between specific capacitive coupling electrodes. One or more ceramic sheets (not shown) are provided between the capacitive coupling electrodes 72 and the capacitive coupling electrodes 74.

The capacitive coupling electrodes 74 are arranged at positions having point symmetry, with the center C of the dielectric substrate 14 (see FIG. 19) in the planar view being the center of symmetry. Specifically, the capacitive coupling electrode 74A and the capacitive coupling electrode 74B are arranged at positions having point symmetry, with the center C of the dielectric substrate 14 in the planar view being the center of symmetry. In the present embodiment, the reason for arranging the capacitive coupling electrodes 74 with point symmetry is to achieve excellent frequency characteristics.

As shown in FIG. 23, the capacitive coupling electrode 74A includes partial patterns (electrode patterns) 74A1 to 74A3. The partial pattern 74A1 is connected to the via electrode portion 20B. The partial pattern 74A3 is positioned on the −Y side of the partial pattern 74A1. The partial pattern 74A3 is connected to the partial pattern 74A1 via the partial pattern 74A2. The partial pattern 74A3 overlaps with the capacitive coupling electrode 70E in the planar view. The size of the partial pattern 74A3 is the same as the size of the capacitive coupling electrode 70E. One end of the capacitive coupling electrode 72E is sandwiched between the capacitive coupling electrode 70E and the partial pattern 74A3.

The capacitive coupling electrode 74B includes partial patterns 74B1 to 74B3. The partial pattern 74B1 is connected to the via electrode portion 20D. The partial pattern 74B3 is positioned to the +Y side of the partial pattern 74B1. The partial pattern 74B3 is connected to the partial pattern 74B1 via the partial pattern 74B2. The partial pattern 74B3 overlaps with the capacitive coupling electrode 70F in the planar view. The size of the partial pattern 74B3 is the same as the size of the capacitive coupling electrode 70F. The other end of the capacitive coupling electrode 72E is sandwiched between the capacitive coupling electrode 70F and the partial pattern 74B3. A capacitive coupling structure 71E is formed by the capacitive coupling electrode 70E, the capacitive coupling electrode 70F, the capacitive coupling electrode 72E, the capacitive coupling electrode 74A, and the capacitive coupling electrode 74B.

As shown in FIG. 24, capacitive coupling electrodes (comb-shaped electrodes, capacitive electrodes) 76A to 76D are formed within the dielectric substrate 14. The capacitive coupling electrodes 76A to 76D are formed in the same layer. In other words, the capacitive coupling electrodes 76A to 76D are formed on the same ceramic sheet (not shown). The reference numeral 76 is used when describing capacitive coupling electrodes without distinguishing therebetween, and the reference numerals 76A to 76D are used when describing capacitive coupling electrodes while distinguishing between specific capacitive coupling electrodes. One or more ceramic sheets (not shown) are provided between the capacitive coupling electrodes 74 (see FIG. 22) and the capacitive coupling electrodes 76.

The capacitive coupling electrodes 76 are arranged at positions having point symmetry, with the center C of the dielectric substrate 14 (see FIG. 19) in the planar view being the center of symmetry. Specifically, the capacitive coupling electrode 76A and the capacitive coupling electrode 76B are arranged at positions having point symmetry, with the center C of the dielectric substrate 14 in the planar view being the center of symmetry. Furthermore, the capacitive coupling electrode 76C and the capacitive coupling electrode 76D are arranged at positions having point symmetry, with the center C of the dielectric substrate 14 in the planar view being the center of symmetry. In the present embodiment, the reason for arranging the capacitive coupling electrodes 76 with point symmetry is to achieve excellent frequency characteristics.

As shown in FIG. 25, the capacitive coupling electrode 76A includes partial patterns (electrode patterns) 76A1 to 76A4. The partial pattern 76A1 is connected to the via electrode portion 20A. The longitudinal direction of the partial pattern 76A2 is the X direction. One end of the partial pattern 76A2 is connected to the partial pattern 76A1. The partial pattern 76A2 protrudes in the +X direction. One end of the partial pattern 76A3 is connected to the other end of the partial pattern 76A2. The longitudinal direction of the partial pattern 76A3 is the Y direction. The partial pattern 76A3 protrudes in the −Y direction. That is, the partial pattern 76A3 protrudes toward the side surface 14e. One end of the partial pattern 76A4 is connected to the partial pattern 76A1. The longitudinal direction of the partial pattern 76A4 is the Y direction. The partial pattern 76A4 protrudes in the +Y direction. The partial pattern 76A4 protrudes along the longitudinal direction of the partial pattern 76A3.

The capacitive coupling electrode 76B includes partial patterns 76B1 to 76B4. The partial pattern 76B1 is connected to the via electrode portion 20E. The longitudinal direction of the partial pattern 76B2 is the X direction. One end of the partial pattern 76B2 is connected to the partial pattern 76B1. The partial pattern 76B2 protrudes in the −X direction. One end of the partial pattern 76B3 is connected to the other end of the partial pattern 76B2. The longitudinal direction of the partial pattern 76B3 is the Y direction. The partial pattern 76B3 protrudes in the +Y direction. The partial pattern 76B3 protrudes along the longitudinal direction of the partial pattern 76A3. One end of the partial pattern 76B4 is connected to the partial pattern 76B1. The longitudinal direction of the partial pattern 76B4 is the Y direction. The partial pattern 76B4 protrudes in the −Y direction. The partial pattern 76B4 protrudes along the longitudinal direction of the partial pattern 76A3.

The capacitive coupling electrode 76C includes partial patterns 76C1 to 76C6. The partial pattern 76C1 is connected to the via electrode portion 20B. The longitudinal direction of the partial pattern 76C2 is the X direction. One end of the partial pattern 76C2 is connected to the partial pattern 76C1. The partial pattern 76C2 protrudes in the −X direction. One end of the partial pattern 76C3 is connected to the other end of the partial pattern 76C2. The longitudinal direction of the partial pattern 76C3 is the Y direction. The partial pattern 76C3 protrudes in the −Y direction. The partial pattern 76C3 protrudes along the longitudinal direction of the partial pattern 76A3. One end of the partial pattern 76C4 is connected to the partial pattern 76C1. The longitudinal direction of the partial pattern 76C4 is the Y direction. The partial pattern 76C4 protrudes in the −Y direction. The partial pattern 76C4 protrudes along the longitudinal direction of the partial pattern 76A3. The longitudinal direction of the partial pattern 76C5 is the X direction. One end of the partial pattern 76C5 is connected to the partial pattern 76C1. The partial pattern 76C5 protrudes in the +X direction. One end of the partial pattern 76C6 is connected to the other end of the partial pattern 76C5. The longitudinal direction of the partial pattern 76C6 is the Y direction. The partial pattern 76C6 protrudes in the +Y direction. The partial pattern 76C6 protrudes toward the side surface 14f. The partial pattern 76C6 protrudes along the longitudinal direction of the partial pattern 76A3.

The capacitive coupling electrode 76D includes partial patterns 76D1 to 76D6. The partial pattern 76D1 is connected to the via electrode portion 20D. The longitudinal direction of the partial pattern 76D2 is the X direction. One end of the partial pattern 76D2 is connected to the partial pattern 76D1. The partial pattern 76D2 protrudes in the +X direction. One end of the partial pattern 76D3 is connected to the other end of the partial pattern 76D2. The longitudinal direction of the partial pattern 76D3 is the Y direction. The partial pattern 76D3 protrudes in the +Y direction. The partial pattern 76D3 protrudes along the longitudinal direction of the partial pattern 76A3. One end of the partial pattern 76D4 is connected to the partial pattern 76D1. The longitudinal direction of the partial pattern 76D4 is the Y direction. The partial pattern 76D4 protrudes in the +Y direction. The partial pattern 76D4 protrudes along the longitudinal direction of the partial pattern 76A3. The longitudinal direction of the partial pattern 76D5 is the X direction. One end of the partial pattern 76D5 is connected to the partial pattern 76D1. The partial pattern 76D5 protrudes in the −X direction. One end of the partial pattern 76D6 is connected to the other end of the partial pattern 76D5. The longitudinal direction of the partial pattern 76D6 is the Y direction. The partial pattern 76D6 protrudes in the −Y direction. That is, the partial pattern 76D6 protrudes toward the side surface 14e.

The partial pattern 76A3 and the partial pattern 76D6 are adjacent to each other. Since the partial pattern 76A3 and the partial pattern 76D6 are adjacent to each other, the capacitive coupling electrode 76A and capacitive coupling electrode 76D are capacitively coupled. A capacitive coupling structure 77A is formed by the capacitive coupling electrode 76A and the capacitive coupling electrode 76D.

The Y-direction position of the partial pattern 76A2 and the Y-direction position of the partial pattern 76D5 are the same. The partial pattern 76A3 and the partial pattern 76D6 both protrude in the −Y direction. That is, the partial pattern 76A3 and the partial pattern 76D6 protrude toward the side surface 14e. The Y-direction position of the partial patterns 76A3 and 76D6 is between the Y-direction position of the partial patterns 76A2 and 76D5 and the Y-direction position of the shield conductor 12Ca.

The reason for having both the partial pattern 76A3 and the partial pattern 76D6 protrude toward the side surface 14e is as follows. In other words, the reason for having both the partial pattern 76A3 and the partial pattern 76D6 protrude in the −Y direction is as follows. In a case where both the partial pattern 76A3 and the partial pattern 76D6 protrude in the +Y direction, the partial patterns 76A3 and 76D6 draw near the partial patterns 76C3, 76C4, and the like. When the partial patterns 76A3 and 76D6 are near the partial patterns 76C3, 76C4, and the like, the partial patterns 76A3 and 76D6 and the partial patterns 76C3, 76C4, and the like become capacitively coupled to each other. Capacitive coupling between the partial patterns 76A3 and 76D6 and the partial patterns 76C3, 76C4, and the like is undesirable. On the other hand, in a case where both the partial pattern 76A3 and the partial pattern 76D6 protrude in the −Y direction, these partial patterns 76A3 and 76D6 do not draw near the partial patterns 76C3, 76C4, and the like. Since the partial patterns 76A3 and 76D6 are not near the partial patterns 76C3, 76C4, and the like, the partial patterns 76A3 and 76D6 and the partial patterns 76C3 and 76C4 do not become capacitively coupled to each other. For this reason, in the present embodiment, both the partial pattern 76A3 and the partial pattern 76D6 protrude toward the side surface 14e.

The partial pattern 76B3 and the partial pattern 76C6 are adjacent to each other. Since the partial pattern 76B3 and the partial pattern 76C6 are adjacent to each other, the capacitive coupling electrode 76B and capacitive coupling electrode 76C are capacitively coupled. A capacitive coupling structure 77B is formed by the capacitive coupling electrode 76B and the capacitive coupling electrode 76C.

The Y-direction position of the partial pattern 76B2 and the Y-direction position of the partial pattern 76C5 are the same. The partial pattern 76B3 and the partial pattern 76C6 both protrude in the +Y direction. That is, the partial pattern 76B3 and the partial pattern 76C6 protrude toward the side surface 14f. The Y-direction position of the partial patterns 76B3 and 76C6 is between the Y-direction position of the partial patterns 76B2 and 76C5 and the Y-direction position of the shield conductor 12Cb.

The reason for having both the partial pattern 76B3 and the partial pattern 76C6 protrude toward the side surface 14f is as follows. In other words, the reason for having both the partial pattern 76B3 and the partial pattern 76C6 protrude in the +Y direction is as follows. In a case where both the partial pattern 76B3 and the partial pattern 76C6 protrude in the −Y direction, the partial patterns 76B3 and 76C6 draw near the partial patterns 76D3, 76D4, and the like. When the partial patterns 76B3 and 76C6 are near the partial patterns 76D3, 76D4, and the like, the partial patterns 76B3 and 76C6 and the partial patterns 76D3, 76D4, and the like become capacitively coupled to each other. Capacitive coupling between the partial patterns 76B3 and 76C6 and the partial patterns 76D3, 76D4, and the like is undesirable. On the other hand, in a case where both the partial pattern 76B3 and the partial pattern 76C6 protrude in the +Y direction, these partial patterns 76B3 and 76C6 do not draw near the partial patterns 76D3, 76D4, and the like. Since the partial patterns 76B3 and 76C6 are not near the partial patterns 76D3, 76D4, and the like, the partial patterns 76B3 and 76C6 and the partial patterns 76D3 and 76D4 do not become capacitively coupled to each other. For this reason, in the present embodiment, both the partial pattern 76B3 and the partial pattern 76C6 protrude toward the side surface 14f.

The partial pattern 76A4 and the partial pattern 76C3 are adjacent to each other. Since the partial pattern 76A4 and the partial pattern 76C3 are adjacent to each other, the capacitive coupling electrode 76A and capacitive coupling electrode 76C are capacitively coupled. A capacitive coupling structure 77C is formed by the capacitive coupling electrode 76A and the capacitive coupling electrode 76C.

The partial pattern 76B4 and the partial pattern 76D3 are adjacent to each other. Since the partial pattern 76B4 and the partial pattern 76D3 are adjacent to each other, the capacitive coupling electrode 76B and capacitive coupling electrode 76D are capacitively coupled. A capacitive coupling structure 77D is formed by the capacitive coupling electrode 76B and the capacitive coupling electrode 76D.

The partial pattern 76C4 and the partial pattern 76D4 are adjacent to each other. Since the partial pattern 76C4 and the partial pattern 76D4 are adjacent to each other, the capacitive coupling electrode 76C and capacitive coupling electrode 76D are capacitively coupled. A capacitive coupling structure 77E is formed by the capacitive coupling electrode 76C and the capacitive coupling electrode 76D.

As shown in FIG. 26, capacitive coupling electrodes (comb-shaped electrodes, capacitive electrodes) 78A to 78C are formed within the dielectric substrate 14. The capacitive coupling electrodes 78A to 78C are formed in the same layer. In other words, the capacitive coupling electrodes 78A to 78C are formed on the same ceramic sheet (not shown). The reference numeral 78 is used when describing capacitive coupling electrodes without distinguishing therebetween, and the reference numerals 78A to 78C are used when describing capacitive coupling electrodes while distinguishing between specific capacitive coupling electrodes. One or more ceramic sheets (not shown) are provided between the capacitive coupling electrodes 76 and the capacitive coupling electrodes 78.

The capacitive coupling electrodes 78 are arranged at positions having point symmetry, with the center C of the dielectric substrate 14 (see FIG. 19) in the planar view being the center of symmetry. Specifically, the capacitive coupling electrode 78A and the capacitive coupling electrode 78B are arranged at positions having point symmetry, with the center C of the dielectric substrate 14 in the planar view being the center of symmetry. Furthermore, the capacitive coupling electrode 78C is formed to have point symmetry, with the center C of the dielectric substrate 14 in the planar view being the center of symmetry. In the present embodiment, the reason for arranging the capacitive coupling electrodes 78 with point symmetry is to achieve excellent frequency characteristics.

As shown in FIG. 27, the capacitive coupling electrode 78A includes partial patterns 78A1 and 78A2. The partial pattern 78A1 is connected to the via electrode portion 20A. The longitudinal direction of the partial pattern 78A2 is the Y direction.

The capacitive coupling electrode 78B includes partial patterns 78B1 and 78B2. The partial pattern 78B1 is connected to the via electrode portion 20E. The longitudinal direction of the partial pattern 78B2 is the Y direction.

The capacitive coupling electrode 78C includes partial patterns 78C1 to 78C3. The longitudinal direction of the partial patterns 78C1 is the Y direction. The partial pattern 78C1 is adjacent to the partial pattern 78A2. The longitudinal direction of the partial pattern 78C2 is the Y direction. The partial pattern 78C2 is adjacent to the partial pattern 78B2. One end of the partial pattern (relay pattern) 78C3 is connected to the partial pattern 78C1. The other end of the partial pattern 78C3 is connected to the partial pattern 78C2. Since the partial pattern 78A2 and the partial pattern 78C1 are adjacent to each other, the capacitive coupling electrode 78A and the capacitive coupling electrode 78C are capacitively coupled. Since the partial pattern 78B2 and the partial pattern 78C2 are adjacent to each other, the capacitive coupling electrode 78B and the capacitive coupling electrode 78C are capacitively coupled.

As shown in FIG. 26, input/output patterns 80A and 80B are also formed within the dielectric substrate 14. The input/output patterns 80A and 80B are formed in the same layer. In other words, the input/output patterns 80A and 80B are formed on the same ceramic sheet (not shown). The reference numeral 80 is used when describing input/output patterns without distinguishing therebetween, and the reference numerals 80A and 80B are used when describing input/output patterns while distinguishing between specific input/output patterns. One or more ceramic sheets (not shown) are provided between the capacitive coupling electrodes 78 and the input/output patterns 80.

As shown in FIG. 27, the input/output pattern 80A includes partial patterns 80A1 and 80A2. One end of the partial pattern 80A1 is connected to the input/output terminal 22A. The other end of the partial pattern 80A1 is connected to the partial pattern 80A2. The partial pattern 80A2 is connected to the via electrode portion 20A. In this way, the input/output terminal 22A is connected to the via electrode portion 20A via the input/output pattern 80A.

The input/output pattern 80B includes partial patterns 80B1 and 80B2. One end of the partial pattern 80B1 is connected to the input/output terminal 22B. The other end of the partial pattern 80B1 is connected to the partial pattern 80B2. The partial pattern 80B2 is connected to the via electrode portion 20E. In this way, the input/output terminal 22B is connected to the via electrode portion 20E via the input/output pattern 80B.

In this way, the input/output terminal 22A is electrically connected to the via electrode portion 20A via the input/output pattern 80A, and the input/output terminal 22B is electrically connected to the via electrode portion 20E via the input/output pattern 80B. In the present embodiment, an external portion Q can be suitably adjusted by suitably setting the Z-direction positions of the input/output patterns 80A and 80B. That is, in the present embodiment, the external portion Q can be suitably adjusted by suitably setting the positions of the input/output patterns 80A and 80B in the longitudinal direction of the via electrode portions 20A and 20E.

As shown in FIG. 26, shielding via electrode portions 81A to 81D are formed within the dielectric substrate 14. The reference numeral 81 is used when describing shielding via electrode portions without distinguishing therebetween, and the reference numerals 81A to 81D are used when describing shielding via electrode portions while distinguishing between specific shielding via electrode portions.

The shielding via electrode portion 81A includes a shielding via electrode 82A and a shielding via electrode 82B. The shielding via electrode portion 81B includes a shielding via electrode 82C and a shielding via electrode 82D. The shielding via electrode portion 81C includes a shielding via electrode 82E and a shielding via electrode 82F. The shielding via electrode portion 81D includes a shielding via electrode 82G and a shielding via electrode 82H. The reference numeral 82 is used when describing shielding via electrodes without distinguishing therebetween, and the reference numerals 82A to 82H are used when describing shielding via electrodes while distinguishing between specific shielding via electrodes. In the example shown in FIG. 28, two shielding via electrodes 82 are included in each single shielding via electrode portion 81, but each single shielding via electrode portion 81 may instead be formed by one shielding via electrode 82.

One end of the shielding via electrode portion 81 is connected to the shield conductor 12A. The other end of the shielding via electrode portion 81 is connected to the shield conductor 12B.

As shown in FIG. 28, the shielding via electrode portion 81A is connected to the shield conductors 12A and 12B, within an extension region 84A realized by extending, in the −Y direction, the region in which the via electrode portion 20A is positioned. That is, the shielding via electrode portion 81A is connected to the shield conductors 12A and 12B in the extension region 84A realized by extending the region in which the via electrode portion 20A is positioned toward the shield conductor 12Ca. In this way, the shielding via electrode portion 81A is formed selectively inside the extension region 84A. The shielding via electrode portion 81A is positioned near the shield conductor 12Ca. The regions where via electrode portions 20 are positioned are regions corresponding to the imaginary rings 26.

The shielding via electrode portion 81B is connected to the shield conductors 12A and 12B, within an extension region 84E realized by extending, in the +Y direction, the region in which the via electrode portion 20E is positioned. That is, the shielding via electrode portion 81B is connected to the shield conductors 12A and 12B in the extension region 84E realized by extending the region in which the via electrode portion 20E is positioned toward the shield conductor 12Cb. The shielding via electrode portion 81B is formed selectively inside the extension region 84E. The shielding via electrode portion 81B is positioned near the shield conductor 12Cb.

The shielding via electrode portion 81C is connected to the shield conductors 12A and 12B, within an extension region 84B realized by extending, in the +Y direction, the region in which the via electrode portion 20B is positioned. That is, the shielding via electrode portion 81C is connected to the shield conductors 12A and 12B in the extension region 84B realized by extending the region in which the via electrode portion 20B is positioned toward the shield conductor 12Cb. The shielding via electrode portion 81C is formed selectively inside the extension region 84B. The shielding via electrode portion 81C is positioned near the shield conductor 12Cb.

The shielding via electrode portion 81D is connected to the shield conductors 12A and 12B, within an extension region 84D realized by extending, in the −Y direction, the region in which the via electrode portion 20D is positioned. That is, the shielding via electrode portion 81D is connected to the shield conductors 12A and 12B in the extension region 84D realized by extending the region in which the via electrode portion 20D is positioned toward the shield conductor 12Ca. The shielding via electrode portion 81D is formed selectively inside the extension region 84D. The shielding via electrode portion 81D is positioned near the shield conductor 12Ca. The reference numeral 84 is used when describing extension regions without distinguishing therebetween, and the reference numerals 84A to 84D are used when describing extension regions while distinguishing between specific extension regions.

The reason for forming the shielding via electrode portions 81 in the present embodiment is as follows. When positional shift occurs during cutting of the dielectric substrate 14, the distances between the via electrode portions 20 and the side surfaces 14e and 14f fluctuate. When the distances between the via electrode portions 20 and the side surfaces 14e and 14f fluctuate, the distances between the via electrode portions 20 and the shield conductors 12Ca and 12Cb fluctuate. This fluctuation in the distances between the via electrode portions 20 and the shield conductors 12Ca and 12Cb causes fluctuation in the filter characteristics and the like. On the other hand, since the shielding via electrode portions 81 are not formed on the side surfaces 14e and 14f, the shielding via electrode portions 81 are not affected by positional shift occurring when cutting the dielectric substrate 14. That is, even if positional shift occurs when cutting of the dielectric substrate 14, the distances between the shielding via electrode portions 81 and the via electrode portions 20 do not fluctuate. For this reason, the shielding via electrode portions 81 are formed in the present embodiment.

The reason for forming the shielding via electrode portions 81 selectively in the extension regions 84 in the present embodiment is as follows. Specifically, the shielding via electrode portions 81 can be formed by forming via holes by irradiating the dielectric substrate 14 with a laser beam and embedding conductors in these via holes. That is, processing having several steps is necessary to form the shielding via electrode portions 81. Therefore, in a case where a large number of shielding via electrode portions 81 are simply arranged along the side surfaces 14e and 14f, favorable productivity cannot be realized. On the other hand, just by arranging the shielding via electrode portions 81 only in the extension regions 84, it is possible to restrict the variation in filter characteristics caused by positional shift occurring during the cutting of the dielectric substrate 14. For this reason, in the present embodiment, the shielding via electrode portions 81 are formed selectively in the extension regions 84.

As described above, in the present embodiment, the number of resonators 11 included in the filter 10 is four. According to the present embodiment, since the number of resonators 11 is relatively low, it is possible to restrict the degree of coupling between resonators 11 and to therefore realize a filter 10 having the desired characteristics.

### Modified Embodiments

The present invention is not limited to the above embodiments, and various configurations can be adopted without deviating from the scope of the invention.

As an example, the first embodiment and the second embodiment may be suitably combined.

Furthermore, in the first embodiment, an example is described of a case in which the number of resonators 11 is five, and in the second embodiment, an example is described of a case in which the number of resonators 11 is four, but the configuration is not limited to these. For example, the number of resonators 11 may be six.

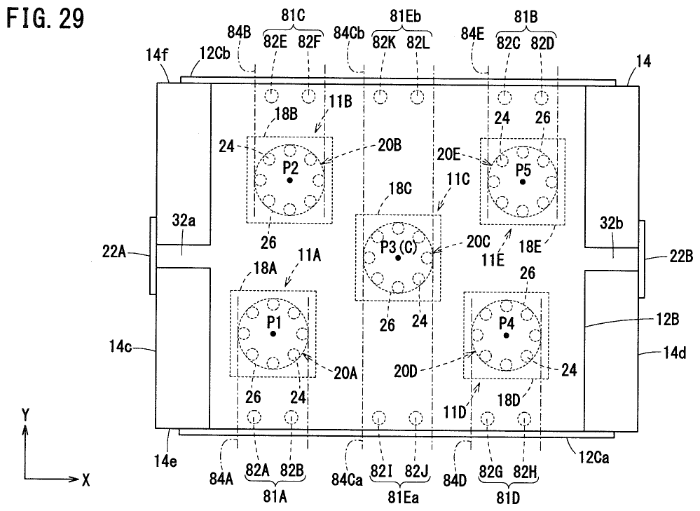

Furthermore, the filter 10 according to the first embodiment may include shielding via electrode portions 81A to 81D, 81Ea, and 81Eb. FIG. 29 is a planar view of an example of a filter according to a modified embodiment. As shown in FIG. 29, the shielding via electrode portions 81A to 81D, 81Ea, and 81Eb are formed within the dielectric substrate 14. The shielding via electrode portions 81A to 81D are the same as the shielding via electrode portions 81A to 81D described above included in the filter 10 of the second embodiment, and therefore descriptions thereof are omitted. The shielding via electrode portion 81Ea includes a shielding via electrode 82I and a shielding via electrode 82J. The shielding via electrode portion 81Eb includes a shielding via electrode 82K and a shielding via electrode 82L. The reference numeral 81 is used when describing shielding via electrode portions without distinguishing therebetween, and the reference numerals 81A to 81D, 81Ea, and 81Eb are used when describing shielding via electrode portions while distinguishing between specific shielding via electrode portions. One end of each shielding via electrode portion 81 is connected to the shield conductor 12A. The other end of each shielding via electrode portion 81 is connected to the shield conductor 12B.

As shown in FIG. 29, the shielding via electrode portion 81Ea is connected to the shield conductors 12A and 12B, within an extension region 84Ca realized by extending, in the −Y direction, the region in which the via electrode portion 20C is positioned. That is, the shielding via electrode portion 81Ea is connected to the shield conductors 12A and 12B in the extension region 84Ca realized by extending the region in which the via electrode portion 20C is positioned toward the shield conductor 12Ca. In this way, the shielding via electrode portion 81Ea is formed selectively inside the extension region 84Ca. The shielding via electrode portion 81Ea is positioned near the shield conductor 12Ca.

The shielding via electrode portion 81Eb is connected to the shield conductors 12A and 12B, within an extension region 84Cb realized by extending, in the +Y direction, the region in which the via electrode portion 20C is positioned. That is, the shielding via electrode portion 81Eb is connected to the shield conductors 12A and 12B in the extension region 84Cb realized by extending the region in which the via electrode portion 20C is positioned toward the shield conductor 12Cb. In this way, the shielding via electrode portion 81Eb is formed selectively inside the extension region 84Cb. The shielding via electrode portion 81Eb is positioned near the shield conductor 12Cb.

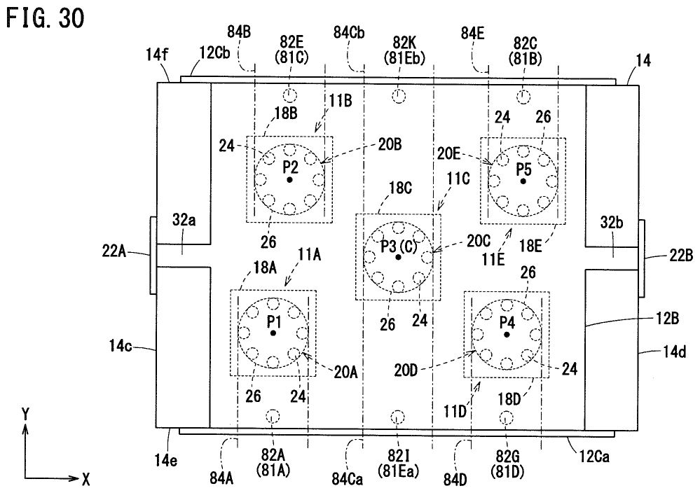

FIG. 30 is a planar view showing an example of a filter according to a modified embodiment. In the example shown in FIG. 30, the single shielding via electrode portion 81 is formed by one shielding via electrode 82. The shielding via electrode portion 81A is formed by the shielding via electrode 82A. The shielding via electrode portion 81B is formed by the shielding via electrode 82C. The shielding via electrode portion 81C is formed by the shielding via electrode 82E. The shielding via electrode portion 81D is formed by the shielding via electrode 82G. The shielding via electrode portion 81Ea is formed by the shielding via electrode 82I. The shielding via electrode portion 81Eb is formed by the shielding via electrode 82K. In this way, each shielding via electrode portion 81 is formed by one shielding via electrode 82.

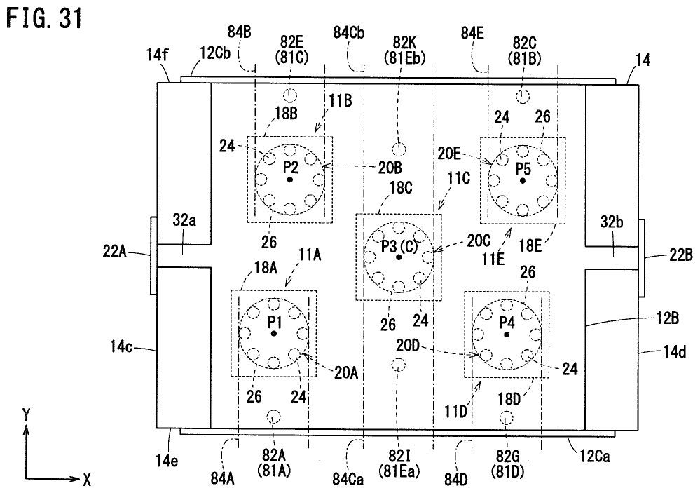

FIG. 31 is a planar view showing an example of a filter according to a modified embodiment. In the example shown in FIG. 31, the shielding via electrode portion 81Ea is positioned in the middle between the via electrode portion 20C and the shield conductor 12Ca. In the example shown in FIG. 31, the shielding via electrode portion 81Ea is not positioned near the shield conductor 12Ca. The Y-direction distance between the shielding via electrode portion 81Ea and the shield conductor 12Ca is greater than the Y-direction distances between the shielding via electrode portions 81A and 81D and the shield conductor 12Ca. In the example shown in FIG. 31, the shielding via electrode portion 81Eb is positioned in the middle between the via electrode portion 20C and the shield conductor 12Cb. That is, in the example shown in FIG. 31, the shielding via electrode portion 81Eb is not positioned near the shield conductor 12Cb. The Y-direction distance between the shielding via electrode portion 81Eb and the shield conductor 12Cb is greater than the Y-direction distances between the shielding via electrode portions 81B and 81C and the shield conductor 12Cb. In this way, the shielding via electrode portion 81Ea may be positioned in the middle between the via electrode portion 20C and the shield conductor 12Ca. Furthermore, the shielding via electrode portion 81Eb may be positioned in the middle between the via electrode portion 20C and the shield conductor 12Cb.

In the first embodiment, an example is described of a case in which the input/output terminals 22A and 22B are connected to the shield conductor 12B via the connection lines 32a and 32b, but the configuration is not limited to this. As an example, the input/output terminals 22A and 22B may be connected to the via electrode portions 20A and 20E via the input/output patterns 80A and 80B (see FIG. 19).

In the second embodiment, an example is described of a case in which the input/output terminals 22A and 22B are connected to the via electrode portions 20A and 20E via the input/output patterns 80A and 80B, but the configuration is not limited to this. As an example, the input/output terminals 22A and 22B may be connected to the shield conductor 12B via the connection lines 32a and 32b (see FIG. 2).

In the modified embodiments described above using FIGS. 29 to 31, an example is described of a case in which the input/output terminals 22A and 22B are connected to the shield conductor 12B via the connection lines 32a and 32b, but the configuration is not limited to this. As an example, the input/output terminals 22A and 22B may be connected to the via electrode portions 20A and 20E via the input/output patterns 80A and 80B (see FIG. 19).

The following is a record of the inventions that can be understood from the embodiments described above.

The filter (10) includes: the dielectric substrate (14); the plurality of resonators (11A to 11E) that are formed within the dielectric substrate and surrounded by the shield conductors (12A, 12B, 12Ca, 12Cb); and the first input/output terminal (22A) and the second input/output terminal (22B) formed in the portion where the shield conductors are not formed, wherein: the first resonator (11A), which is the resonator nearest the first input/output terminal among the plurality of resonators, and the second resonator (11E), which is the resonator nearest the second input/output terminal among the plurality of resonators, are arranged in a positional relationship with point symmetry, with the center (C) of the dielectric substrate in the planar view being the center of the point symmetry; the third resonator (11B) among the plurality of resonators and the fourth resonator (11D) among the plurality of resonators are arranged in a positional relationship with point symmetry, with the center of the dielectric substrate in the planar view being the center of the point symmetry; the position of the third resonator in the first direction, which is the longitudinal direction of the dielectric substrate, is between the position of the first resonator in the first direction and the position of the center of the dielectric substrate in the first direction; and the position of the fourth resonator in the first direction is between the position of the second resonator in the first direction and the position of the center of the dielectric substrate in the first direction. With this configuration, the resonators are arranged with point symmetry, and thus it is possible to provide a filter having excellent characteristics.

The filter described above may further include the capacitive coupling structure (54) included between the resonators, and the capacitive coupling structure may include: the first electrode (50A) that extends from one of the resonators; the second electrode (50B) that extends from another of the resonators toward the first electrode, and has the tip portion that is separated from the first electrode in the side view; and the third electrode (50C) having one end that overlaps with the first electrode in the planar view and the other end that overlaps with the second electrode in the planar view.

In the filter described above, the capacitive coupling structure may further include: the fourth electrode (50Ab) that extends from the one resonator and overlaps with the first electrode (50Aa) in the planar view; and the fifth electrode (50Bb) that extends from the other resonator toward the fourth electrode, overlaps with the second electrode (50Ba) in the planar view, and has the tip portion that is separated from the fourth electrode; the one end (50Ca) of the third electrode may be positioned between the first electrode and the fourth electrode in the side view; and the other end (50Cb) of the third electrode may be positioned between the second electrode and the fifth electrode in the side view.

In the filter described above, the one end of the third electrode may overlap with at least one corner portion of the first electrode in the planar view; and the other end of the third electrode may overlap with at least one corner portion of the second electrode in the planar view.

The filter described above may include: the first electrode (50A) that extends from one of the resonators; the second electrode (50B) that extends from another of the resonators toward the first electrode, and has the tip portion that overlaps with the first electrode in the planar view; the third electrode (50C) that extends from the one resonator; and the fourth electrode (50D) that extends from the other resonator toward the third electrode, and has the tip portion that overlaps with the third electrode in the planar view.

In the filter described above, the first electrode may overlap with at least one corner portion of the second electrode in the planar view; and the fourth electrode may overlap with at least one corner portion of the third electrode in the planar view.

In the filter described above, the capacitive coupling structures (61A to 61F) may be included respectively between the plurality of resonators; each of the capacitive coupling structures may include the capacitive electrode (60ac, 60ab) extending from one of the resonators and the capacitive electrode (60ca, 60ba) extending from another of the resonators; and the portion of the capacitive electrode extending from the one resonator and the portion of the capacitive electrode extending from the other resonator may be near each other.

In the filter described above, the distance (g2) between the capacitive electrodes (60ac, 60ca) in the first capacitive coupling structure (61A) among the plurality of capacitive coupling structures may be greater than the distance (g1) between the capacitive electrodes (60ab, 60ba) in the second capacitive coupling structure (61C) among the plurality of capacitive coupling structures.

In the filter described above, the dielectric substrate may include two principal surfaces (14a, 14b) and four side surfaces (14c to 14f); the distance between the first side surface (14e) among the four side surfaces and the first resonator may be less than the distance between the first side surface and the third resonator; and the filter further may further include the first capacitive coupling structure (77A) that includes the first electrode pattern (76A3), which is connected to the first resonator and protrudes toward the first side surface, and the second electrode pattern (76D6), which is connected to the fourth resonator and protrudes toward the first side surface.

The filter described above may further include: the second capacitive coupling structure (77C) that includes the third electrode pattern (76A4) connected to the first resonator and the fourth electrode pattern (76C3) connected to the third resonator; and the third capacitive coupling structure (77E) that includes the fifth electrode pattern (76C4) connected to the third resonator and the sixth electrode pattern (76D4) connected to the fourth resonator. The first electrode pattern, the second electrode pattern, the third electrode pattern, the fourth electrode pattern, the fifth electrode pattern, and the sixth electrode pattern may be formed in the same layer; and the third electrode pattern, the fourth electrode pattern, the fifth electrode pattern, and the sixth electrode pattern may protrude along the longitudinal direction of the first electrode pattern.

In the filter described above, the plurality of resonators may be provided respectively with the plurality of via electrode portions (20A, 20B, 20D, 20E); the filter may include the capacitive coupling structure (71A) that includes the first electrode pattern (70A3), which is connected to the via electrode portion among the plurality of via electrode portions, the second electrode pattern (70C2), which is connected to the via electrode portion among the plurality of via electrode portions, and the capacitive coupling electrode (72A) having one end that overlaps with the first electrode pattern in the planar view and another end that overlaps with the second electrode pattern in the planar view; the dimension (W12) of the capacitive coupling electrode in the width direction of the capacitive coupling electrode may be less than the dimension (W11) of the first electrode pattern in the width direction of the capacitive coupling electrode; there may be second regions (73A2, 73A3) where the capacitive coupling electrode does not overlap with the first electrode pattern, on both sides of the first region (73A1) where the capacitive coupling electrode and the first electrode pattern overlap; and the dimension difference (W11-W12), which is a value obtained by subtracting the dimension of the capacitive coupling electrode in the width direction of the capacitive coupling electrode from the dimension of the first electrode pattern in the width direction of the capacitive coupling electrode, may be greater than or equal to 1.4 times the inter-electrode distance (d1) that is the distance between the capacitive coupling electrode and the first electrode pattern in the thickness direction of the capacitive coupling electrode.

In the filter described above, the dimension difference may be greater than or equal to 2.6 times the inter-electrode distance.

In the filter described above, the first shield conductor (12A) among the plurality of shield conductors may be formed on one principal surface side of the dielectric substrate; the second shield conductor (12B) among the plurality of shield conductors may be formed on another principal surface side of the dielectric substrate; the third shield conductor (12Ca) among the plurality of shield conductors may be formed on the first side surface of the dielectric substrate; the fourth shield conductor (12Cb) among the plurality of shield conductors may be formed on the second side surface that faces the first side surface; each of the plurality of resonators may include the via electrode portion (20A to 20E) formed within the dielectric substrate and the capacitor electrode (18A to 18E) that faces the first shield conductor and is connected to one end of the via electrode portion; the filter may further include the shielding via electrode portion (81A to 81D, 81Ea, 81Eb) that has one end connected to the first shield conductor and another end connected to the second shield conductor; and the shielding via electrode portion may be selectively formed within the extension region (84A, 84B, 84Ca, 84Cb, 84D, 84E) obtained by extending the region in which the via electrode portion is formed toward the third shield conductor or the fourth shield conductor.

1. A filter comprising:
a dielectric substrate;
a plurality of resonators that are formed within the dielectric substrate and surrounded by shield conductors; and
a first input/output terminal and a second input/output terminal formed in a portion where the shield conductors are not formed, wherein:
a first resonator, which is a resonator nearest the first input/output terminal among the plurality of resonators, and a second resonator, which is a resonator nearest the second input/output terminal among the plurality of resonators, are arranged in a positional relationship with point symmetry, with a center of the dielectric substrate in a planar view being a center of the point symmetry;
a third resonator among the plurality of resonators and a fourth resonator among the plurality of resonators are arranged in a positional relationship with point symmetry, with the center of the dielectric substrate in the planar view being a center of the point symmetry;
a position of the third resonator in a first direction, which is a longitudinal direction of the dielectric substrate, is between a position of the first resonator in the first direction and a position of the center of the dielectric substrate in the first direction; and
a position of the fourth resonator in the first direction is between a position of the second resonator in the first direction and the position of the center of the dielectric substrate in the first direction.

2. The filter according to claim 1, further comprising:
a capacitive coupling structure included between the resonators, wherein the capacitive coupling structure includes:
a first electrode that extends from one resonator of the resonators;
a second electrode that extends from another resonator of the resonators toward the first electrode, and includes a tip portion that is separated from the first electrode in a side view; and
a third electrode including one end that overlaps with the first electrode in the planar view and another end that overlaps with the second electrode in the planar view.

3. The filter according to claim 2, wherein:
the capacitive coupling structure further includes:
a fourth electrode that extends from the one resonator and overlaps with the first electrode in the planar view; and
a fifth electrode that extends from the other resonator toward the fourth electrode, overlaps with the second electrode in the planar view, and includes a tip portion that is separated from the fourth electrode;
the one end of the third electrode is positioned between the first electrode and the fourth electrode in the side view; and
the other end of the third electrode is positioned between the second electrode and the fifth electrode in the side view.

4. The filter according to claim 3, wherein:
the one end of the third electrode overlaps with at least one corner portion of the first electrode in the planar view; and
the other end of the third electrode overlaps with at least one corner portion of the second electrode in the planar view.

5. The filter according to claim 1, comprising:
a first electrode that extends from one resonator of the resonators;
a second electrode that extends from another resonator of the resonators toward the first electrode, and includes a tip portion that overlaps with the first electrode in the planar view;
a third electrode that extends from the one resonator; and
a fourth electrode that extends from the other resonator toward the third electrode, and includes a tip portion that overlaps with the third electrode in the planar view.

6. The filter according to claim 5, wherein:
the first electrode overlaps with at least one corner portion of the second electrode in the planar view; and
the fourth electrode overlaps with at least one corner portion of the third electrode in the planar view.

7. The filter according to claim 1, wherein:
a plurality of capacitive coupling structures are included respectively between the resonators;
each of the capacitive coupling structures includes a capacitive electrode extending from one resonator of the resonators and a capacitive electrode extending from another resonator of the resonators; and
a portion of the capacitive electrode extending from the one resonator and a portion of the capacitive electrode extending from the other resonator are near each other.

8. The filter according to claim 7, wherein:
a distance between the capacitive electrodes in a first capacitive coupling structure among the plurality of capacitive coupling structures is greater than a distance between the capacitive electrodes in a second capacitive coupling structure among the plurality of capacitive coupling structures.

9. The filter according to claim 1, wherein:
the dielectric substrate includes two principal surfaces and four side surfaces;
a distance between a first side surface among the four side surfaces and the first resonator is less than a distance between the first side surface and the third resonator; and
the filter further comprises a first capacitive coupling structure that includes a first electrode pattern, which is connected to the first resonator and protrudes toward the first side surface, and a second electrode pattern, which is connected to the fourth resonator and protrudes toward the first side surface.

10. The filter according to claim 9, further comprising:
a second capacitive coupling structure that includes a third electrode pattern connected to the first resonator and a fourth electrode pattern connected to the third resonator; and
a third capacitive coupling structure that includes a fifth electrode pattern connected to the third resonator and a sixth electrode pattern connected to the fourth resonator, wherein:
the first electrode pattern, the second electrode pattern, the third electrode pattern, the fourth electrode pattern, the fifth electrode pattern, and the sixth electrode pattern are formed in a same layer; and
the third electrode pattern, the fourth electrode pattern, the fifth electrode pattern, and the sixth electrode pattern protrude along a longitudinal direction of the first electrode pattern.

11. The filter according to claim 1, wherein:
the plurality of resonators are provided respectively with a plurality of via electrode portions;
the filter comprises a capacitive coupling structure that includes a first electrode pattern, which is connected to a via electrode portion among the plurality of via electrode portions, a second electrode pattern, which is connected to a via electrode portion among the plurality of via electrode portions, and a capacitive coupling electrode including one end that overlaps with the first electrode pattern in the planar view and another end that overlaps with the second electrode pattern in the planar view;
a dimension of the capacitive coupling electrode in a width direction of the capacitive coupling electrode is less than a dimension of the first electrode pattern in the width direction of the capacitive coupling electrode;
there are second regions where the capacitive coupling electrode does not overlap with the first electrode pattern, on both sides of a first region where the capacitive coupling electrode and the first electrode pattern overlap; and
a dimension difference, which is a value obtained by subtracting the dimension of the capacitive coupling electrode in the width direction of the capacitive coupling electrode from the dimension of the first electrode pattern in the width direction of the capacitive coupling electrode, is greater than or equal to 1.4 times an inter-electrode distance that is a distance between the capacitive coupling electrode and the first electrode pattern in a thickness direction of the capacitive coupling electrode.

12. The filter according to claim 11, wherein:
the dimension difference is greater than or equal to 2.6 times the inter-electrode distance.

13. The filter according to claim 1, wherein:
a first shield conductor among the plurality of shield conductors is formed on one principal surface side of the dielectric substrate;
a second shield conductor among the plurality of shield conductors is formed on another principal surface side of the dielectric substrate;
a third shield conductor among the plurality of shield conductors is formed on a first side surface of the dielectric substrate;
a fourth shield conductor among the plurality of shield conductors is formed on a second side surface that faces the first side surface;
each of the plurality of resonators includes a via electrode portion formed within the dielectric substrate and a capacitor electrode that faces the first shield conductor and is connected to one end of the via electrode portion;
the filter further comprises a shielding via electrode portion that includes one end connected to the first shield conductor and another end connected to the second shield conductor; and
the shielding via electrode portion is selectively formed within an extension region obtained by extending a region in which the via electrode portion is formed toward the third shield conductor or the fourth shield conductor.
